(19) United States
(12) Patent Application Publication
(10) Pub. No.: US 2026/0228138 A1
(43) Pub. Date: Aug. 6, 2026

(54) CONTROL SYSTEM AND METHOD

(71) Applicant: Tokyo Electron Limited, Tokyo (JP)

(72) Inventors: Brayden Box, Albany, NY (US); Daniel Fulford, Albany, NY (US)

(21) Appl. No.: 19/045,339

(22) Filed: Feb. 4, 2025

(51) Int. Cl. G06F 13/10

(52) U.S. Cl. CPC G06F 13/10; G06F 2213/40

(57) ABSTRACT

A method for controlling a device includes receiving a request from a top level system with a first processor core of a first edge core, determining, how and when to respond to the request with the first processor core of the first edge core, and executing the request with a second processor core of the first edge core by operating a peripheral coupled with the second processor core.

### TECHNICAL FIELD

The present invention relates generally to control systems, and, in particular embodiments, to control system frameworks built around microcontroller-based controllers and methods of operating the same.

### BACKGROUND

In modern control systems, effective communication and coordination between various components are crucial for performance and functionality. As systems grow in complexity and scale, managing the interactions between different hardware elements and software modules becomes increasingly challenging.

Traditionally, control systems have relied on centralized architectures where a single main controller oversees all operations. While this approach can be effective for simpler setups, it often struggles to keep pace with the demands of more complex, distributed systems. As the number of components increases, centralized systems may encounter limitations in processing power, scalability, and fault tolerance.

To address these challenges, various communication protocols and fieldbus technologies have been developed. These solutions aim to standardize communication between devices and enable more modular and scalable designs for control/automation systems. Common fieldbus implementations include Profibus, Modbus, and others, which use specific message formats and connection standards. Fieldbuses help simplify and reduce wiring, essentially daisy-chaining many devices together.

While fieldbuses have improved interoperability and modularity in control systems, they often come with their own set of limitations. Devices compatible with a particular fieldbus protocol may be more expensive due to the additional components required to implement the protocol. Additionally, users may find themselves restricted to an ecosystem of devices compatible with the protocol, potentially limiting flexibility in system design and hardware selection. Fieldbuses can also be limited in network topology and can also be susceptible to single points of failure, when a single device failure or cable issue can result in at worst an entire system fault, or at the least interruption of all downstream connections.

A recent, modern development in the area of fieldbuses is Ether CAT. Ether CAT is a fieldbus built on the Ethernet standard. A big focus of Ether CAT is conserving many of the benefits of fieldbuses while also realizing increased system wide real-time synchronization through the idea of distributed clocks. Ether Cat P further expands on Ether CAT by incorporating power into the communication signals (similar to PoE, power over Ethernet), thereby simplifying wiring even more. Ether CAT also implements advanced diagnostics and error handling, and other system features.

However, there are some drawbacks to Ether CAT. The issue of single-point-of-failure is still present due to the fieldbus nature. Expensive, specialized hardware is required in order to implement Ether CAT. Hot swapping of controllers and real time reconfiguration is also limited. Also, in regards to design philosophy, Ether CAT is considered more of a distributed IO system versus a distributed control system, with the goal being gathering/distributing data from distributed IO modules in a deterministic, real time method. The actual system implementation and logic is still performed on some top level “Master” controller.

Some fieldbus implementations include complex troubleshooting methods, such as Ether CAT. However, oftentimes this complex error handling and troubleshooting relies on the state of the communication network. For example, if the fieldbus is down, or the connection is interrupted, it may not be possible to troubleshoot or obtain the necessary error information.

### SUMMARY

In accordance with an embodiment, a method for controlling a device includes: receiving a request from a top level system with a first processor core of a first edge core; determining, with the first processor of the first edge core, how and when to respond to the request; and executing the request with a second processor core of the first edge core by operating a peripheral coupled with the second processor core.

In accordance with another embodiment, a method for controlling a device includes: receiving a first command with a first interpreCore; interpreting the first command with the first interpreCore; generating a plurality of commands based on the interpretation with the first interpreCore, turning the first command into a single different command, or passing the first command through the first interpreCore unchanged to a first eCore coupled with the first interpreCore; and in response to determining that the plurality of commands were generated, transmitting a command from the plurality of commands to the first eCore.

In accordance with yet another embodiment, a method of operating a robot includes: transmitting a command for robot operation from a top level system to an interpreCore; interpreting the command for robot operation with the interpreCore; generating a plurality of commands based on the interpretation with the interpreCore; receiving a first command of the plurality of commands with a first processor core of a first eCore, the first eCore being coupled with a first robot part; and executing the command with a second processor core of the first eCore to operate the first robot part.

It is to be understood that both the foregoing general description and the following detailed description are exemplary and explanatory only and are not restrictive of the disclosure, as claimed.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a block diagram of an edge core, in accordance with some embodiments;

FIG. 2 illustrates a schematic diagram of a layered structure of an edge core, in accordance with some embodiments;

FIG. 3 illustrates a schematic diagram of a system comprising an edge core, in accordance with some embodiments;

FIG. 4 illustrates a block diagram of an edge core software package, in accordance with some embodiments;

FIG. 5 illustrates a block diagram of a method for concurrent troubleshooting of an edge core, in accordance with some embodiments;

FIG. 6 illustrates a block diagram of a system structure comprising edge cores, in accordance with some embodiments;

FIG. 7 illustrates a diagram of interconnection of an edge core with a network, in accordance with some embodiments;

FIG. 8 illustrates a system comprising an interpreter controller, in accordance with some embodiments;

FIG. 9 illustrates a flow chart diagram of an operation of an interpreter controller, in accordance with some embodiments;

FIG. 10 illustrates a flow chart diagram of another operation of an interpreter controller, in accordance with some embodiments;

FIGS. 11A and 11B illustrates a robot arm coupled with edge cores at intermediate stages of operation, in accordance with some embodiments;

FIG. 12 illustrates a block diagram of an interpreter controller, in accordance with some embodiments;

FIG. 13 illustrates a block diagram of a multi-level system, in accordance with some embodiments;

FIG. 14 illustrates a block diagram of different order superCores, in accordance with some embodiments;

FIG. 15 illustrates a process flow chart diagram of a method for controlling a device, in accordance with some embodiments;

FIG. 16 illustrates a process flow chart diagram of a method for controlling a device, in accordance with some embodiments; and

FIG. 17 illustrates a process flow chart diagram of a method of operating a robot, in accordance with some embodiments.

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

A control system method is desired that achieves goals such as reduced/simplified cabling, flexible and expandable topologies, handling hot swapping and rapid, regular reconfiguration, and a combination of power and communication lines, while also introducing new goals. In a particular case, control systems for semiconductor tools in the research and development sector, a need exists to quickly develop and implement control systems for various tool designs and quickly iterate, expand, and improve on the design as fast as possible (in other words, to achieve faster cycles of learning). Since semiconductor tools share many components and/or ‘subsystems’, re-usability of hardware/software between tools and projects is desirable in order to reduce development time. Many subsystems in semiconductor tools can operate nearly independently with minimal dependencies. As such, a goal is to break a control system down into as many smaller, independent sub-systems as possible, or in other words into ‘building blocks’ which can be used across designs. These building blocks then have need of a method to be combined into a larger system, with the goal of that method being to centralize the logic into a single contained touch-point within the system, minimizing as much as possible the re-configuration needed for new designs, which is arguably the most difficult characteristic to achieve for a control system method. Such a system should be very robust in regards to the additions or removals of various subsystems, and reconfigurations, and potentially even capable of automatic reconfiguration or dependency changes. Methods are also desired for combining and standardizing power and communications connections, to further reduce complexity, costs, and time of installations. Finally, off the shelf hardware, for the control system modules, cables, and other system components, is desired to be used, to reduce costs and improve flexibility as much as possible. In the following, a control system approach will be disclosed which aims to tie all these goals into a single control methodology, and will elaborate on the differentiating approaches.

According to one or more embodiments of the present disclosure, this application relates to embodiments of a modular control system framework based on microcontroller controllers. In one or more embodiments, the system comprises a hierarchical arrangement of microcontroller-based controllers, including edge cores (eCores), interpreCore controllers, and gateway controllers, which may communicate over a common communication bus. This modular approach offers several advantages over traditional control systems. By distributing control functions across multiple specialized controllers, the system achieves greater scalability, flexibility, modularity, and extensibility compared to centralized architectures. The use of cost-effective microcontrollers as the basis for each controller helps reduce overall system costs while maintaining robust functionality. For example, microcontrollers such as Raspberry Pi Pico microcontrollers may be used, with individual prices in the low single digits of dollars.

Furthermore, the modular nature of the framework allows for independent development, testing, and troubleshooting of individual components, streamlining system integration and maintenance processes. With these implementations, the risk of hardware obsolescence may be removed from the main control system and placed on an inexpensive microcontroller device or module, which can be swapped with no changes to the control system. The system is scalable, and by adding controllers, processing power is added to the control system in the form of distributed controllers, thereby using localized computing rather than centralized computing. System communication is chosen and designed at the discretion of the user and is not limited to any protocol. The architecture of the system also provides enhanced fault tolerance, as controllers can continue to function or maintain state even if other parts of the system experience issues. These features combine to create a control system framework that is more adaptable, cost-effective, and resilient than many existing solutions.

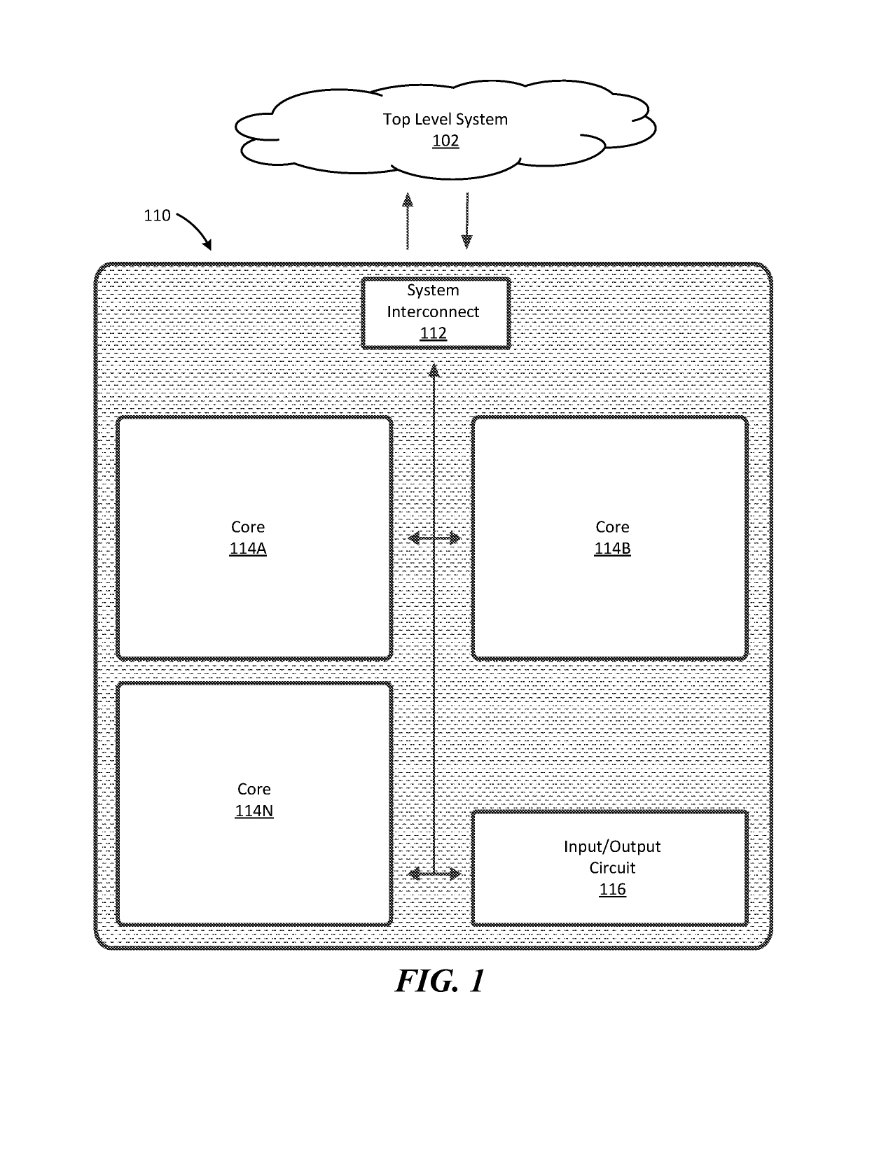

FIG. 1 illustrates an eCore 110, according to embodiments of the present disclosure. The eCore 110 (also referred to as an edge-core) may be the foundational building block of desired control systems. In some embodiments, the eCore is implemented using, for example, an off-the-shelf multi-core microcontroller. FIG. 1 illustrates a generic organization of such a controller including a system interconnect 112 which is some form of a system interconnection that couples the eCore 110 to some system bus protocol. The system bus protocol serves as the primary means of data exchange within the system and couples the top level system 102 with the eCore 110. In various embodiments, this system bus protocol can implement any suitable communication protocol, such as Ethernet, CAN, I2C, or any other suitable bus protocol, standardized or custom-designed, and can be either wired or wireless. The choice of protocol can be tailored to the specific needs of the application, providing flexibility in system design.

The system bus protocol may be used to couple the eCore 110 with a top level system 102, which represents a main controller or a high-level control computer. In various embodiments, this could be a central processing unit, a personal computer, a user interface, or any other suitable high-level control device capable of overseeing the entire system operation.

Each eCore 110 may be implemented using a microcontroller with two or more processor cores, although implementations with a single core are also possible. In the illustrated example of FIG. 1, the eCore 110 comprises two cores 114A, 114B and an nth core 114N representing the presence of some number N cores. Typically, one core (e.g., core 114A) handles communication, data requests, and the like via the system interconnect 112, while the other core(s) manage the interaction with connected hardware (e.g., various peripherals) coupled through one or more respective input/output circuits 116 and perform various important processing tasks.

In various embodiments, the core dedicated to communication handling (e.g., core 114A) is configured to use a system protocol built on an existing communication standard, such as I²C (Inter-Integrated Circuit), Ethernet, Serial Peripheral Interface (SPI), USB (Universal Serial Bus), FireWire, or the like. The core(s) dedicated to hardware handling (e.g., core(s) 114B through 114N) are configured with user-set, hardware specific functionality, such as specific to the coupled peripheral(s) 120. The hardware handling of the core(s) dedicated to hardware handling is correlated with a command set handled by the core dedicated to communication handling.

In various embodiments, the eCores 110 are capable of in-place troubleshooting. This means that a user can connect directly to an individual eCore 110 deployed in the system and view status messages, updates, error messages, etc., via a direct connection to the individual eCore 110. This troubleshooting capability is independent of the communication bus or any other communication protocol internal to the system and can be used to diagnose both communication issues and controller functionality/control issues. For example, the troubleshooting capability may be used to confirm desired functionality of the eCores and chase bugs or other software, firmware, or hardware issues in each eCore 110. This ability to troubleshoot individual eCores 110, each of which is divided or modularized according to function, is advantageous for developing functionality of the system.

In various embodiments, a computer with a live terminal is coupled with, or connected to, the eCore 110 for troubleshooting or analysis. The eCore 110 is configured to print statements to the terminal, which can display status, commands received and executed, hardware control updates, errors or warnings, and the like. This may be performed for each eCore 110 by a direct connection to the eCore 110 (e.g., through a USB connection or the like) while the eCore 110 is running in the system. This is advantageous for troubleshooting deployed eCores 110. In some embodiments, a custom microcontroller is used for troubleshooting the eCores 110. The custom microcontroller may couple or connect to the eCore 110 wirelessly and provides in-place troubleshooting functionality with a more accessible terminal or window. The custom microcontroller may be further configured to perform logging of eCore 110 performance and to display multiple terminal windows for handling different types of messages such as general status, error or warning messages, and the like.

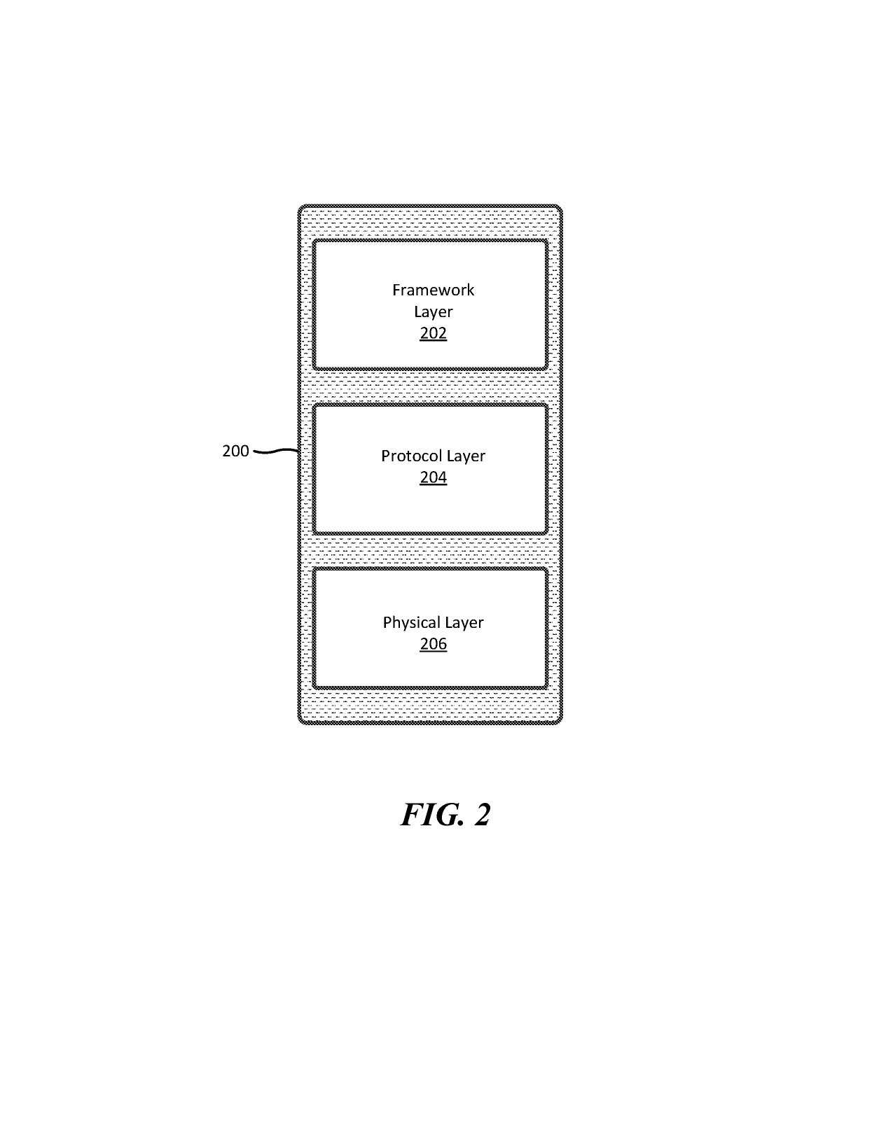

FIG. 2 illustrates an example layered structure 200 of the eCore 110 (see above, FIG. 1), in accordance with some embodiments. The protocol is handled within the module (e.g., the eCore 110), and then some core which primarily handles communication-based tasks will handle the protocol of a chosen framework, which is layered on top of the chosen communication protocol. As illustrated in FIG. 2, a chosen protocol layer 204 (for example, a generic protocol) is built on some physical layer 206 (for example, 4 pair Ethernet), and the framework layer 202 (which is to be defined) is implemented on top of these layers. Hence this framework aims to be independent of the chosen protocol, although particular protocols may provide particular benefits).

In various embodiments, an eCore 110 is implemented using actor resemblance. A common software design pattern is the Actor approach. For example, the paper by Jie Liu, J. Eker, J. W. Janneck, Xiaojun Liu and E. A. Lee, “Actor-oriented control system design: a responsible framework perspective," in IEEE Transactions on Control Systems Technology, vol. 12, no. 2, pp. 250-262, March 2004, doi: 10.1109/TCST.2004.824310, which is hereby incorporated by reference in its entirety, describes a generic control system based on actors (in other words, re-usable units), in order to promote a control system design methodology in software which includes actors and interconnections. Disclosed controllers of this disclosure may apply some of the ‘Actor” software design methodologies to a hardware entity, such as the eCore 110, thus creating a differentiating application and implementation. The eCore 110 described above with respect to FIG. 1 is capable of having states or not having states (in other words, of operating deterministically) and will operate as an independent entity. In various embodiments, the eCore 110 is capable of receiving and sending communication, but the eCore 110 itself will determine how/when to respond to the communication, such as with the core dedicated to communication handling. As such, in some embodiments the eCore 110 will not operate in a classic master-slave relationship seen in many distributed control systems/fieldbus implementations. Hence, it is be beneficial to consider the eCore having properties of a ‘hardware actor’.

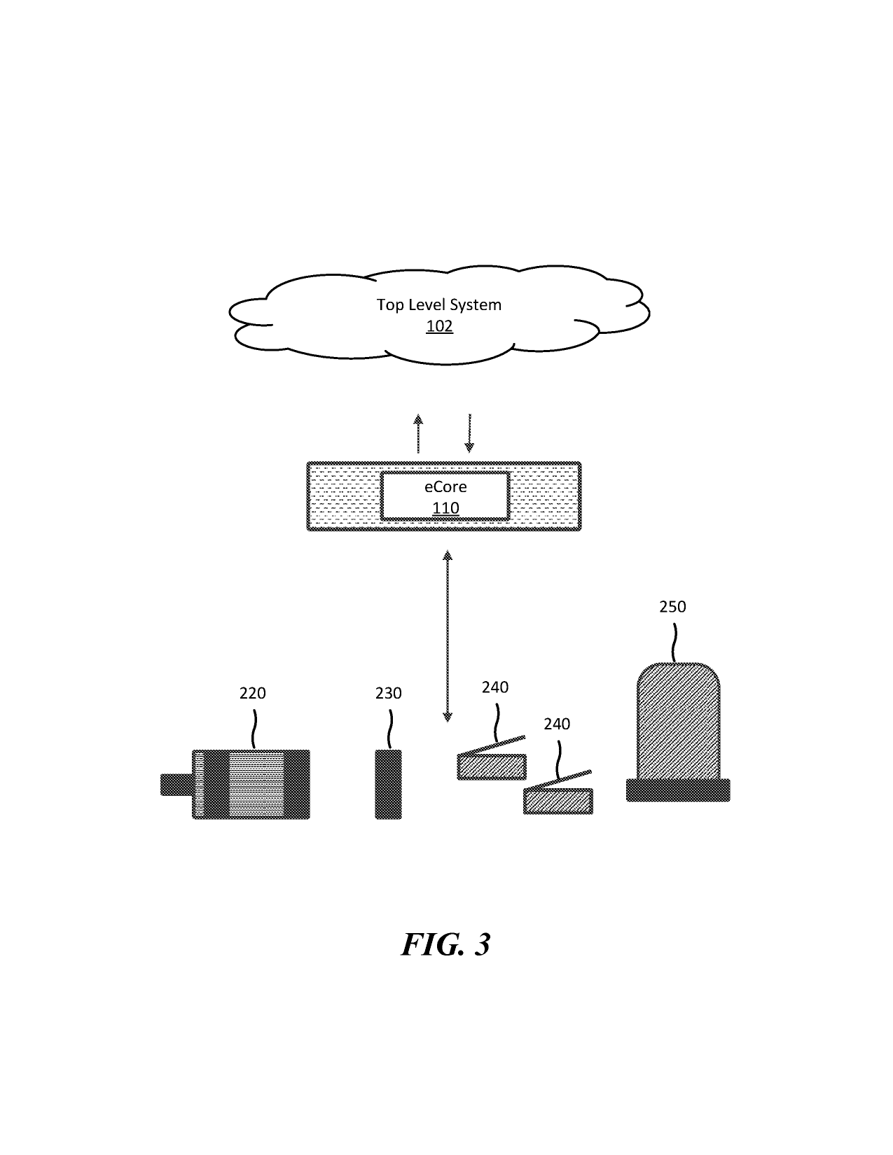

FIG. 3 illustrates an example system design with an eCore 110. The eCore 110 is designed to control a small system, for example a loading mechanism for a semiconductor tool including motion components such as a stepper motor 220, an encoder 230, limit switches 240, and a corresponding slot valve 250. In various embodiments, the eCore 110 completely encapsulates all functionality for such a subsystem of the larger semiconductor tool and effectively works as an abstraction layer between the entire loading system and the rest of the system for the tool (e.g., the top level system 102), similar to how an operating system abstracts hardware details from the processes which run on the computer. It is also important to note that the eCore 110 is designed in a manner entirely independent of the target system, and the eCore 110 may be designed as generically as possible. In accordance with some embodiments of designs for the eCore 110, all hardware details of the loading subsystem can be abstracted away from the rest of the semiconductor tool, better modularizing the system and improving component reuse as well as future reconfiguration, hardware swaps/replacements, and expansion. The eCore 110 is capable of operating independently from any other system and can be controlled on its own as a standalone system. The eCore 110 is also capable of operating completely independently of the presence of communication; for example, the eCore 110 will operate whether or not another unit is present and requesting actions. Once an eCore 110 is developed as the building block for a control system, the eCore 110 may remain unchanged while being assembled into a system, which is advantageous for minimizing changes and improving re-use of eCores 110 between projects.

In various embodiments, design/development of an eCore 110 may follow a design philosophy in which functionality for the subsystem is entirely encapsulated. When considering the command/request set by which other units can request actions of the eCore 110, a generic interface is created to increase the ease of future reuse.

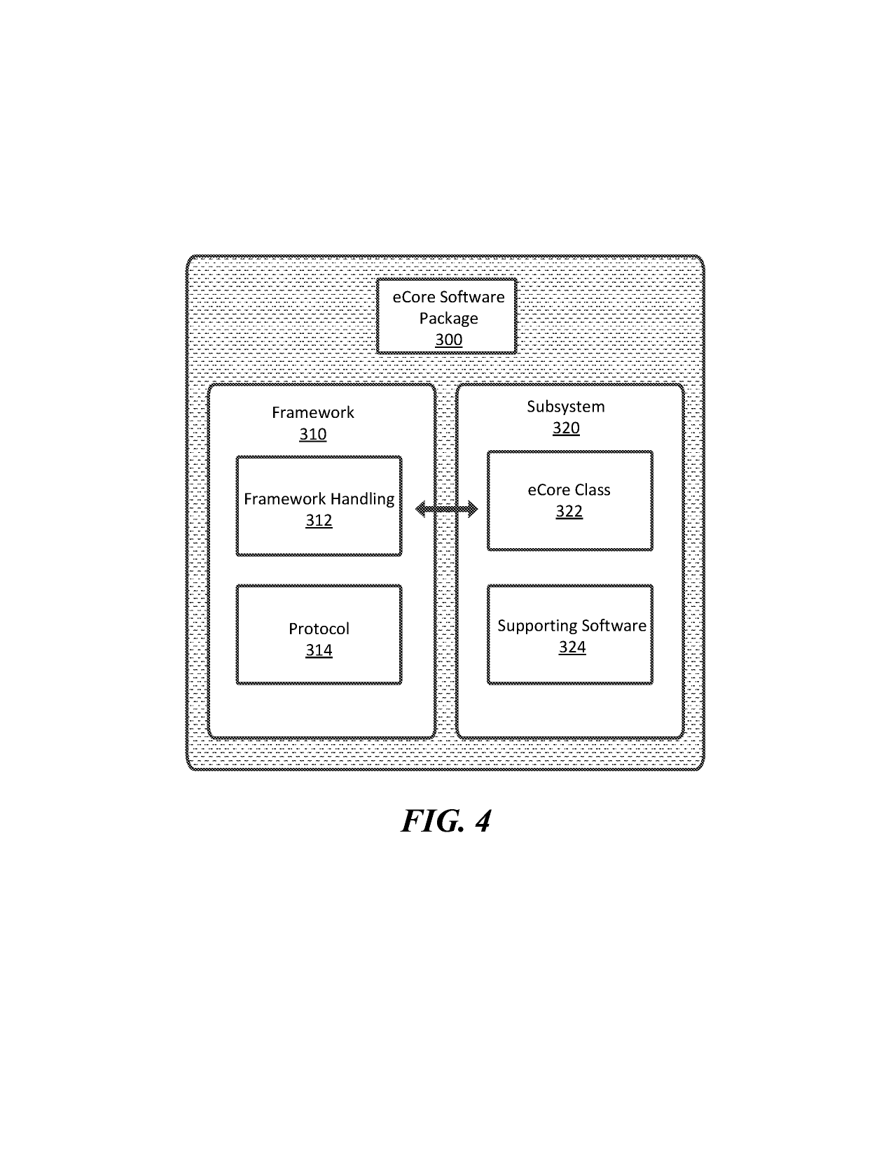

FIG. 4 illustrates a block diagram of an eCore software package 300, in accordance with some embodiments. The eCore software package 300 comprises a method for class linkage to directly link the command/request set and the framework messaging scheme. A class or similar construct (e.g., the eCore class 322) is used when designing a new eCore to establish what subsystem (e.g., a subsystem 320) the eCore implements as a whole, as illustrated in FIG. 4. For example, the eCore class 322 is included as part of the subsystem 320. Then, class methods are used to establish what actions can be requested of the eCore. This eCore class 322 is then automatically and/or dynamically linked to framework handling software (e.g., a framework handling 312) of a framework 310 that is also part of the eCore software package 300. The framework 310 may further include a generic protocol software (e.g., a protocol 314).Whenever the eCore class 322 is changed or updated, the list of requests which the eCore can handle (and corresponding parameters, return values, and the like) are automatically updated and available as soon as the eCore is run.

In some implementations, the eCore class 322 is created using Python or another common programming language, such as for an eCore for the aforementioned loader subsystem described above with respect to FIG. 3. A handful of requests are described as class methods with keyword parameters (known as kwargs in Python). Other functionality and any sort of state control is set up elsewhere in supporting software 324 of the subsystem 320, as illustrated in FIG. 4. When the eCore is run, the framework handling 312 receives messages and/or requests over the framework 310, which may be on top of the protocol layer 204 as described above with respect to FIG. 2. The framework 310 is aware of the eCore class 322, as each eCore implements a respective eCore class 322 that directly describes the type of subsystem 320 it aims to be/control. The framework 310 dynamically checks whether the eCore class 322 contains the function type which the received messages denotes. If the eCore class 322 contains the method, then it checks the keyword arguments (kwargs) dynamically via a Python dictionary, again checking for proper formatting and/or value types. If successful, the message and/or request is then passed to the control handling of the eCore to determine which actions should be taken for the specified function call. In this manner, software changes can be made quickly and regularly, with no changes being needed to integrate into the framework 310.

Embodiments of the disclosure can implement OOH (Object Oriented Hardware). Object Oriented methods can be used between various sets/families of systems. For example, other implementations of loading systems for a tool may have more motors, various accessories, or different brands of hardware, but these can be used with common and/or generic interfaces. Doing so can greatly reduce software development time for new eCores, especially if created child eCore software packages inherit from some generic parent eCore software package. The created child eCore software packages may also add to/extend the class from the generic parent eCore software package. This can be implemented with the eCore class 322 as illustrated by the eCore software package 300 in FIG. 4. Benefits go beyond the eCore software development. Since class linkage directly ties the eCore class 322 of an eCore into its function request set which is presented/available to the greater system, the common interface is not just in the eCore software package 300 but extends into the messaging within the framework 310. As such, an eCore child implementation can be directly substitutable with its parent eCore with no changes to the framework 310. This is advantageous not only for saving time and encouraging re-use in the software development aspect of framework design, but also for quick iteration and experimentation within control systems with similar but various hardware implementations.

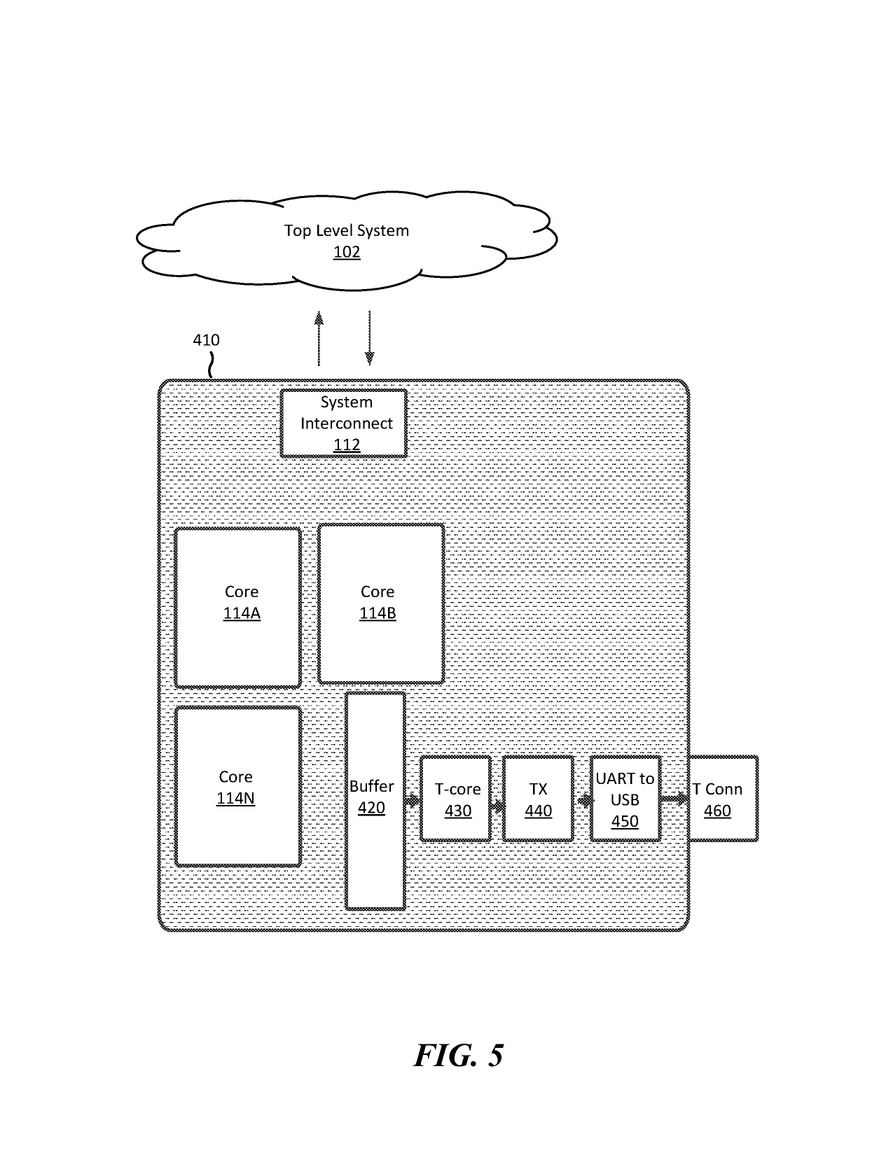

FIG. 5 illustrates a method for concurrent troubleshooting for an eCore 410, in accordance with some embodiments. The eCore 410 may be similar to the eCore 110 as described above with respect to FIG. 1, comprising, for example, a system interconnect 112 and core(s) 114A, 114B, to 114N, and the details are not repeated herein. The method of troubleshooting for the eCore 410 may be entirely independent of the framework interconnections and also concurrent with the operation of the eCore 410. Use of the troubleshooting method has no effect on the operation of the eCore 410; in other words, the eCore 410 should not be aware of whether troubleshooting is occurring or not. At least two motivations for the troubleshooting method include: it is desirable for quick and concurrent troubleshooting while developing an eCore, such as for status updates, error reporting, and other such features; and, once an eCore is deployed in a system, it is advantageous to have a concurrent method of troubleshooting which is independent of the communication interconnections/state of the system. This method separates communication/framework issues from eCore internal issues, greatly simplifying troubleshooting. The method includes a direct connection to a specific eCore with a connection separate from the framework/system connection. In some implementations, such as with microcontrollers, the method includes utilizing a buffer 420 as part of the eCore 410. Any suitable form of buffer, whether Direct Memory Access (DMA), First In First Out (FIFO), or other appropriate form may be used for the buffer 420. This buffer 420 is accessible from all of the core(s) 114A, 114B, to 114N on the eCore 410.

In various implementations, such as with a microcontroller such as the Raspberry RP2040, the eCore 410 has two processing cores (e.g., Arm Cortex-M0+ processing cores) and also a number of state machines, such as eight small PIO state machines. The PIO state machines are very small, simplified processors capable of handling a limited machine code instruction set. Each PIO state machine has a FIFO buffer (e.g., the buffer 420), and the PIO state machine is capable of implementing a serial protocol, which could be custom or existing, such as Universal Asynchronous Receiver-Transmitter (UART), or even a wireless method such as Wi-Fi. This is the T-core 430 illustrated in FIG. 5. This PIO state machine implements the serial protocol and sends via some transmission (TX) 440 such as a port or GPIO pin. This could then optionally be intercepted by a UART to USB converter 450 and finally sent to a T(ransmission) conn(ection) 460, such as an open USB connection. In operation, cores 114A to 114N send updates, error codes, and other messages (via framework overrides, or programmed) to the buffer 420. The PIO state machine (e.g., the T-core 430) processes and output these messages into serially transmitted data as soon as they are received, regardless of whether a USB/cable is present. Essentially, serial data is constantly being written to some port, illustrated as T conn 460 in FIG. 5, whether a connection is present or not. In this manner, whenever a connection is made, serial data will already be present to be picked up and read by some external program, which can apply necessary formatting to present data to the user or developer. The presence of a troubleshooting connection is entirely irrelevant to the operation of both the eCore 410, and the T-core 430. Since this functionality is offloaded to a simple, dedicated piece of hardware, for example in some implementations a RP2040 PIO state machine, it adds very little overhead to system operation. And, since this may be implemented inexpensively via custom hardware or as shown with existing hardware such as the RP2040, cost may not be significantly increased.

Returning to FIG. 4, a basic eCore (edge-core) software package 300 comprises a framework package (e.g., the framework 310) to handle communications and framework-related functionality and a subsystem package (e.g., the subsystem 320) which encapsulates and defines all functionality for the target subsystem of the specific eCore. In various embodiments, eCores contain multiple subsystem packages. These subsystem packages may be entirely independent, and in some examples only one subsystem package runs on the eCore at a time. In some implementations, the hardware of an eCore is some generic off-the-shelf microcontroller. Microcontrollers may contain re-configurable general purpose input/output (GPIO) pins that support pin re-mapping or reconfiguration between different subsystem packages.

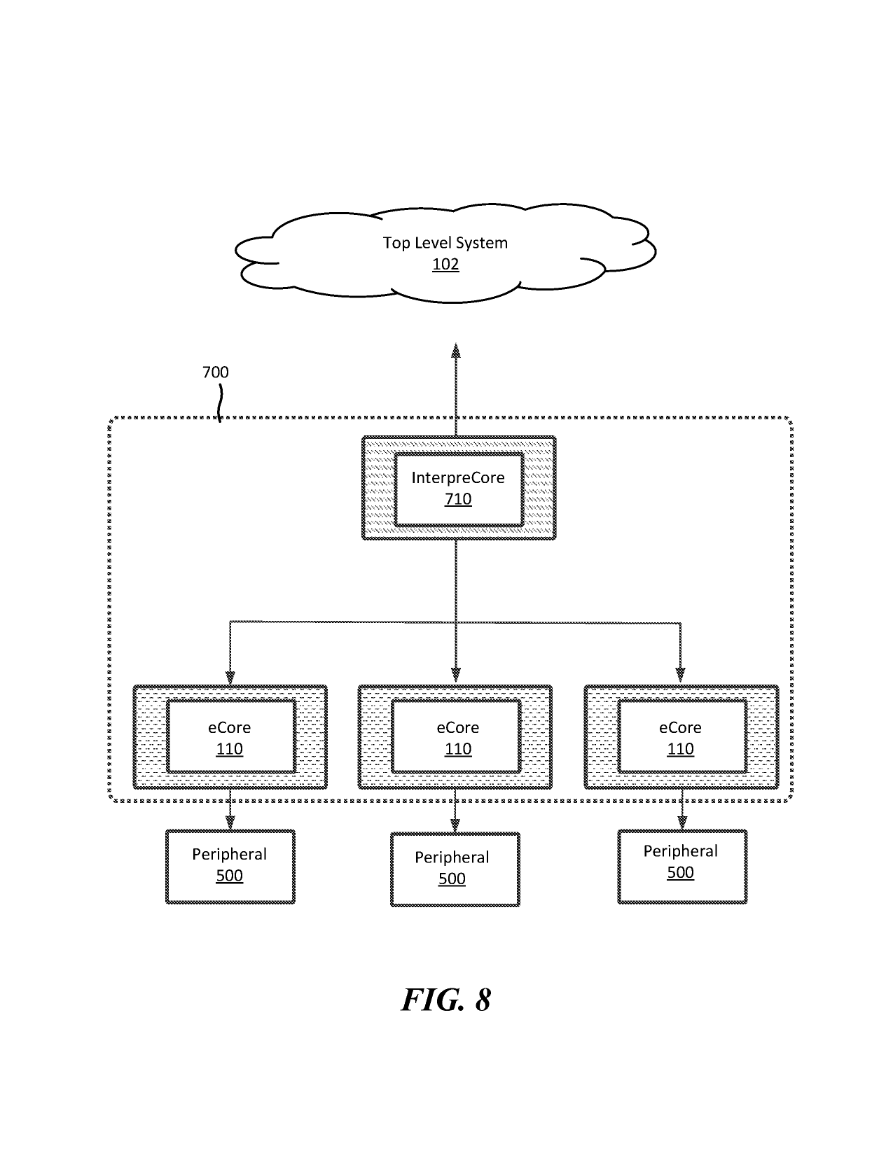

Interconnection of the eCore to an outside system may be more fixed, and may be done via printed circuit board (PCB) connectors, cables, wires, or the like. In various examples, custom hardware, such as on a PCD, is implemented to allow for reconfigurable system interconnections. This may be done by some reconfigurable method such as multiplexing (also referred to as muxing) the I/O lines to various connectors, wires, or the like. Such reactive reprogramming or reconfiguration may also be performed or triggered by an interpreCore, which is described below with respect to FIG. 8. Also, an eCore can be made to receive complete subsystem packages over the framework. This may allow for remote updates of the current subsystem package or the addition of new subsystem packages to a particular eCore. This is advantageous for situations such as if physical access to a particular eCore is restricted.

The above configuration may set up an eCore for role switching, which may also be described as reactive reprogramming. In various embodiments, an eCore is capable of switching which subsystem software package it is running, thereby changing its current defining class and morphing into an effectively different eCore. This switch could occur at the request of the greater system, or it could occur in a reactive method, such as in response to some external or internal trigger. With the previously described custom hardware, system I/O interconnections may be dynamically reconfigured and allow the (eCore) edge-core to swap between which subsystem it implements and which peripherals it currently controls. In some embodiments, this method used to develop a dynamically adaptive method to control systems.

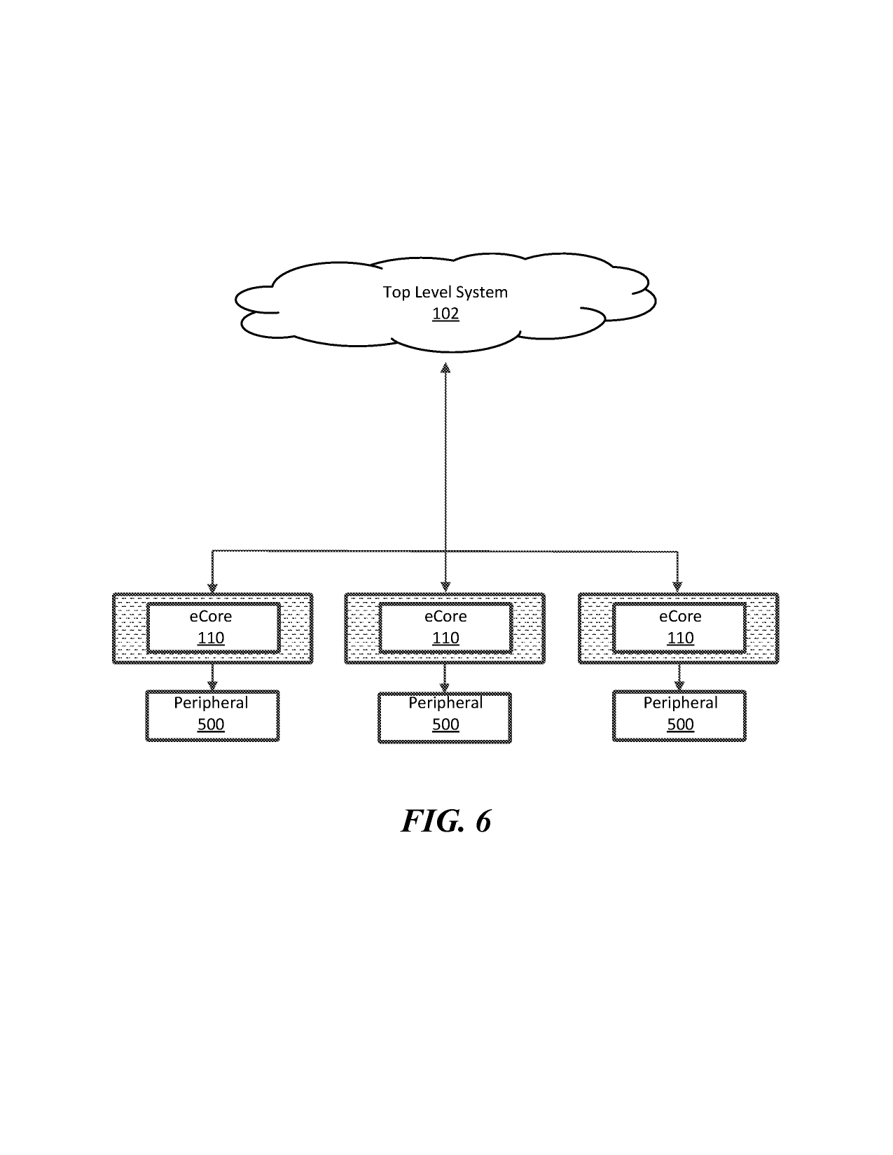

FIG. 6 illustrates a basic system structure comprising eCores, in accordance with some embodiments. Some number N eCores 110, such as three eCores 110 in the illustrated example of FIG. 6, are coupled via the bus of the desired communication protocol with each other and with a top level system 102. However, any suitable number N of the eCores 110 may be included. Each eCore 110 independently manages its own subsystem, which comprises one or many peripherals 500. In various embodiments, the peripherals 500 include sensors, actuators, motors, servos, robot parts, or any other type of device relevant to the application of the subsystem.

In some implementations, the eCores 110 are coupled via a network switch and Ethernet cables. The eCores110 are then integrated into some broader system (e.g., the top level system 102) via the same bus. The eCores 110 are capable of handling requests sent into the network and desirably have some form of addressing. In some implementations, the communication protocol is Ethernet but IP addresses are not used as the addressing scheme in the network. Instead, descriptive identifiers are programmed into each device by way of software or some configuration file in the software. eCores 110 can also have some hardware form of addressing, such as dip switches or rotary knobs, and be selectable between hardware and software addressing. Descriptive software identifiers can be useful for tracking and identifying a specific eCore 110 in the system, such as with some arbitrary or hexadecimal number. eCores 110 in general theory resemble actors rather than a classic master-slave relationship between system components. eCores 110 are also capable of sending requests to other eCores 110 of parts of the system.

Messages can be broadcast across the framework network. One example of message broadcasting is user datagram protocol (UDP) broadcasting, which is advantageous for decoupling units in a framework. Connections are not required and do need to be maintained, helping to promote independence and decoupling in the network. By adopting broadcasting, the physical addressing method in many communication protocols becomes irrelevant, as in Ethernet, I2C, or the like. Addressing/identification can be performed in the framework layer 202, as described above with respect to FIG. 2. This can be done in software, such as with configuration files or some method to set the software identifier for a particular eCore 110 or component, or in hardware as described above. In embodiments in which all messages are broadcast across the network, the framework handling software in eCores 110 will analyze all received messages by quickly checking a specified location in each message packet or data, for example the identifier or address. If matched, the eCore 110 proceeds to process and send the message for handling; if not, the message is discarded and ignored.

Whenever a component or eCore 110 sends out a function request, a response is expected. This could be an ack (acknowledgement) message, an error message (if the requested functionality cannot be performed, or eCore/component is in an error state), or the like. As communication connections through wires are not present, determining whether the target eCore 110 has been disconnected or is unable to be communicated with can be performed using timeouts. These timeouts are arranged at the discretion of the developer for each type of request message. If no ack, error, or response message is received after sending a request within a timeout, then the sender can determine to take whatever corrective action as necessary. Using this method is advantageous for encouraging the independence and decoupling of components within the framework.

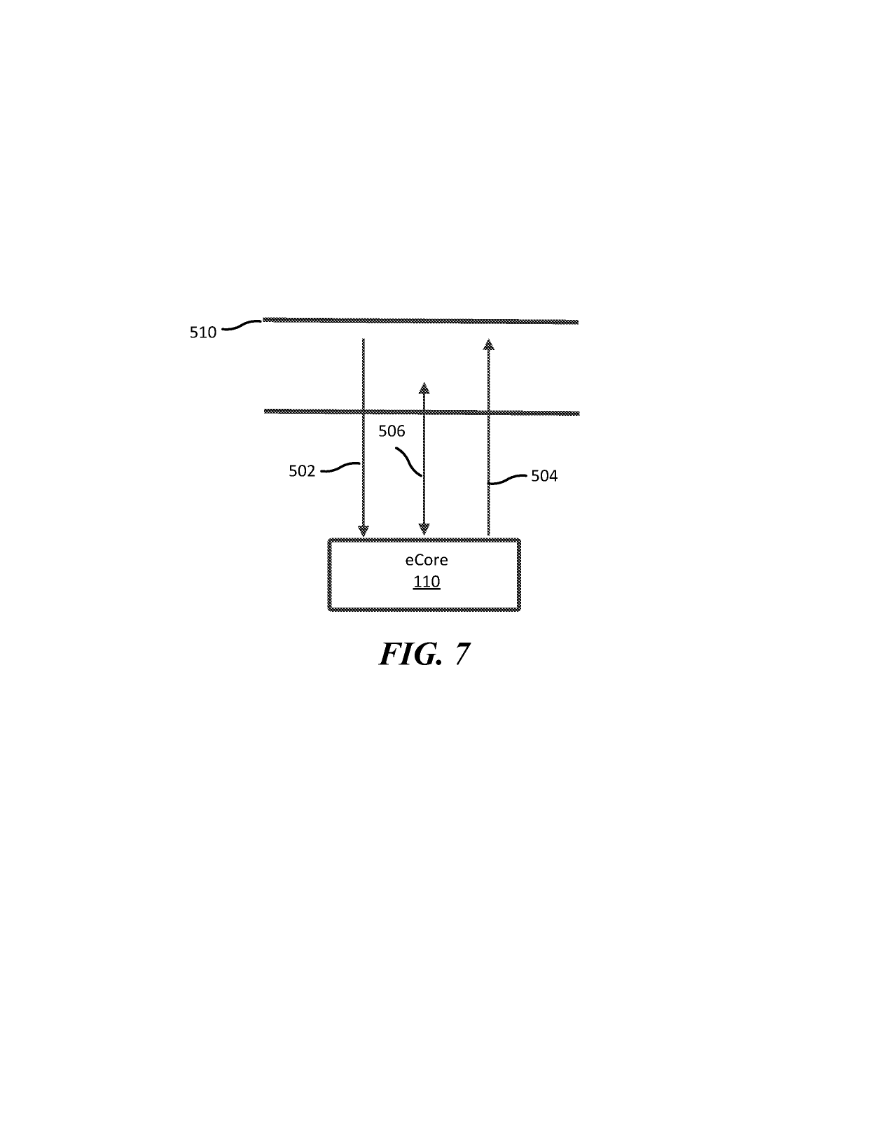

An eCore 110 can monitor and respond to network messages having a broadcast nature through three functions or categories. Network/communication bus traffic can be divided into three main categories from the perspective of an eCore 110: inbound requests, outbound requests, and common secondaries. Inbound requests may be function requests received from other eCores 110 or components in the framework, outbound requests are function requests sent by the eCore 110 to other eCores 110 or components in the system, and common secondaries include the expected response messages from a function request, such as an ack or error message. In some implementations, Ethernet protocol is used. While all network traffic is transmitted over the same wire pairs physically, group network traffic can be grouped according to these three functions. For example, UDP broadcast groups, a particular feature of Ethernet, can be described as grouped or divided channels of communication within the Ethernet network. One such group may be used for framework function requests, and one other group may be used for common secondaries. As such, FIG. 7 illustrates interconnection to the network communications in an abstract way from an eCore point of view. Channel 502 is a channel that is constantly reading from a communications bus 510. In some Ethernet implementations, this channel 502 reads from the function request UDP group. Channel 504 is another channel that writes function requests to the same UDP group. Finally, channel 506 is a direction-swappable channel for reading and writing common secondary messages. In examples where function requests are processed sequentially by the eCore 110 and not concurrently, the reading and writing of the common secondary UDP group will be mutually exclusive and race conditions will be avoided. As such, a permanent listener/channel on the UDP function request group ensures that no function requests are missed by the eCore 110, a switchable channel is on the UDP common secondary message group, and a third channel is available for writing to the UDP function request group. These channels, in an Ethernet implementation, may be implemented as software sockets either listening or writing to a particular UDP group.

As described above, eCores act as a hardware abstraction layer between the system and the hardware, reducing or eliminating the risk of hardware obsolescence from the greater system. However, eCores may also abstract implementation away from the greater system. In the example of the loader as described above with respect to FIG. 3, one function request could be ‘pick from chamber 1’. The details about motion positions, number of motor axis, and the path the loading arm chooses to take may be abstracted away from the system. Designing eCores in such a manner provides two significant benefits. A first benefit is that the interface is smaller and more abstract which simplifies system design when assembling these eCores into a system. A second benefit is that if OOH (Object oriented hardware) principles are applied, then eCores can be created as hardware classes that implement common interfaces.Functionality such as parent-child relationships/inheritance, the extension of parent classes, and overrides can all be realized. For example, in various loader systems, one loader system may have multiple motor axes, another may have only a single motor, and some use linear actuators versus rotational motors, each with very different supporting hardware. A common interface for a family/class of loader systems is provided by abstracting functionality overriding common functions in each implementation.

In some embodiments, control systems including eCores have a hot swappable property. eCores may not impact system communications if present or not in comparison with classic fieldbuses in which a removed device or missing connection can take down the entire chain. If object oriented hardware (OOH) has been applied to a class of eCores, that class of eCores may be hot-swappable in the system. No changes or re-configuration are needed in order for the swap to take effect; neither does the system need to be taken offline to make the change. As long as the eCores are swapped in a reasonable amount of time, such as based on the design decisions of the developer in the framework, the greater system will not realize a change has occurred or that the new eCore is different from the prior eCore. In some examples, a loader system is being upgraded from a single linear actuator to a three axis loading system. The eCores have been designed in an OOH manner by implementing common interfaces. The three axis loading system implements the inherited parent functionality, as does the single linear actuator, but also introduces new functionality under its new class with its increased hardware capabilities. The new loader system is installed in a framework based on the Ethernet protocol, and the old single linear actuator eCore is removed. The new eCore is connected to the network via, for example, an Ethernet cable. Care is taken to give the new eCore the same identifier as the previous. The greater system will now continue to operate with the same functionality as before, given that the new eCore has been designed and implemented correctly, and will not realize a change has taken place. The greater system be changed at any later time to take advantage of the greater functionality provided by the new eCore.

As described above eCores can resemble actors in general operation. This means that as independent entities, eCores not only handle function requests but are also capable of sending function requests to other parts of the greater system or to other eCores. In various examples, an eCore is created to mimic a classic master-slave relationship to handle function requests as well as sending function requests to other parts of the greater system or to other eCores. In an example of a loader subsystem, this may be implemented to only handle function requests and to not send any function requests out into the framework.

However, relationships between eCores in a system may be unavoidable at times, whether due to data sharing, sequence of events, or other issues. If an eCore was designed to send function requests to other specific eCores in the framework/system, this would break the design philosophy goal, which is to have independent building blocks by which to build up such a system. If an eCore desirably references other parts of the system specifically, a web of dependencies is created, eliminating the independent nature of the eCores. A method using an interpreter is advantageous for handling such cases.

In various embodiments, a new building block for such a framework is an interpreter controller, also referred to as an interpreCore. As described above, eCores may be considered more or less as static building blocks for a greater system once they have been developed. A method is desirable in order to combine these static building blocks into a greater framework/system, potentially in various levels, one that may create a central ‘touch-point’ of logic in the system, which is a desirable goal of such a framework. This dynamic, volatile building block, is an interpreter, which is also described as an interpreCore, will serve this purpose.

In various examples, various eCores are developed for various subsystems that are part of a greater system, for example the aforementioned loader subsystem, which are part of a greater semiconductor tool. Each of these implements a class-linked interface that is generic, yet specific, to its operation/subsystem. The user interface, PC, or other part of the greater system also has some interface which it implements. The interface may be very generic and abstract but may relate to various combinations and sequences of the interface functions from each eCore. For example, when considering operating the loader module, there may be other dependencies desirably included before an operation which involves the loader can execute, such as checking states in other eCore subsystems. As such, not only the eCore interfaces, but also other system component interfaces (GUIs, PCs, or the like) can be developed independently of any other system components (in other words, without knowledge of system configuration) to encourage generic, abstract interfaces. Then, the interpreCore is desirably used as the single point of logic to tie all the components together into a functioning system, thus centralizing the framework logic into a single-point of contact.

In some embodiments, the interpreCore implements the concept of ‘command-level logic’, which can be abbreviated as CLL. For example, a greater system comprising a few eCores 110 is described above with respect to FIG. 6. An interpreCore 710 can be added into the first (and in the example of FIG. 6, the only) communication layer between the other, or rest, of the system, and the eCores, as illustrated in FIG. 8. In a manner similar to how an eCore 110 acts as an abstraction layer between hardware and the rest of the system, the interpreCore 710 acts as an abstraction layer between upper system and lower system logic. This is also referred to as acting at a command level. All system dependencies and inter-component logic may be placed (components being eCores 110 and other units in the system) into such a centralized point of contact.

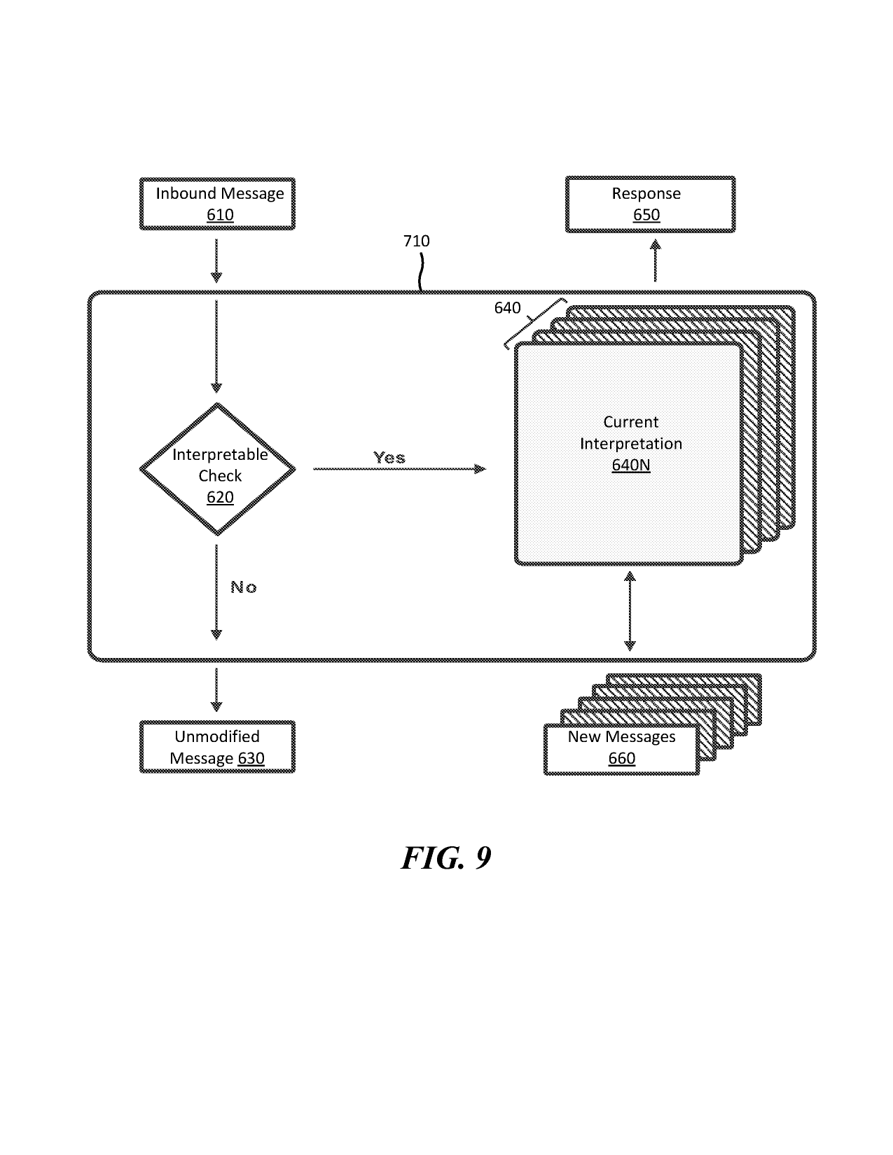

FIG. 9 illustrates a flow chart diagram of an operation of an interpreCore 710, such as described above with respect to FIG. 8, performing interpretation in a top down manner. In some example where the Ethernet protocol is used, an inbound message 610 (e.g., an inbound message packet) between, for example, a top level system 102 and an eCore 110 is received, as illustrated in FIG. 8. This inbound message 610 is intercepted by the interpreCore 710. The interpreCore 710 then performs an interpretable check 620 by checking some identifier such as some bit in the message packet or a full lookup of the ID and function name to determine whether the message is interpretable or not. If not, then the interpreCore 710 forwards the unmodified message 630 through the network into the lower framework section 700, as illustrated in FIG. 8 comprising three eCores 110. In this case, the interpreCore 710 is invisible to normal framework operation.

If the message is interpretable, then the interpreCore 710 finds the correct interpretation matrix, which could be a file such as a spreadsheet or comma separated value file from a stored interpretation library 640 of such files. Each interpretable message in the framework (or that part of the framework) may have an interpretation matrix. The received message may have been very generic with no specifications regarding the system configuration/layout. The interpreCore 710, as the centralized point-of-contact for framework logic, may contain all information regarding system configuration and logic. The interpreCore 710 may choose to interpret the received message with a current interpretation 640N from the interpretation library 640 into a sequence of multiple new messages 660, a conditional sequence, or other complex system logic. The interpretation matrix will specify the specific functions to send, function parameters, the identifiers/addresses of the eCores 110 in the framework, and any logic, conditions, delays, or timeouts necessary. This allows the interpreCore 710 to generate a plurality of commands based on the interpretation of the received message (such as a command). For example, if the interpreCore 710 decides that a message should be interpreted into a sequence of three functions for three different eCores 110, each of which relies on the success of the prior function (cumulative), the interpreCore 710 is capable of handling all responses/cases from each eCore from each function call, whether affirmative or negative, and is capable of responding to the greater system in the affirmative or positive, even if a sequence ends up being terminated. After interpretation is finished, the interpreCore responds to the initially received message as specified in the interpretation matrix with a response 650.

This interpreCore 710 provides unique benefits in framework design. The function requests that the interpreCore 710 handles from the greater system can be extended with no changes to any other existing part of the system. New eCores 110 can be added to the lower framework section 700 as illustrated in FIG. 8 and can be entirely integrated into the system by updating the CLL in the interpretation matrices of the interpreCore 710. An existing eCore 110 can be swapped for one that does not share a common interface. By updating the CLL in the interpretation matrices, the existing eCore 110 can be incorporated as a replacement in the system with no other changes to other eCores 110 or components. Entire framework logic can be modified, reconfigured, or extended by modifying the function sequences, conditions, parameter values, or the like in the interpretation matrices, again with no changes anywhere else in the system. This is an useful advantage, for example in control system design in the semiconductor research and development sector. To be able to add to, reconfigure, and reprogram a system at a single touch point without extensive rework is desirable for such an environment, not to mention that the fundamental building blocks (eCores) can be kept entirely independent from project-specific implementation/functionality details (which may be in the interpreCore), vastly improving eCore (including both hardware and software) re-use between projects and applications. Libraries of eCores (in other words, standard groups and configurations of eCores analogous to software libraries) and class families of eCores may be developed, such as for the semiconductor research and development sector. Following these developments, the additional work in developing future control systems that share eCore subsystems will be configuring the interpreCore to combine all desired eCore building blocks to perform the desired system functionality.

As described above, it may be advantageous for eCore design to mimic a master-slave relationship in some examples. If an eCore is used to only handle function requests and does not need to send any function requests to any other parts of the framework, dependencies can be virtually eliminated. However, cases may exist where this is infeasible, such as where one eCore subsystem may need data, conditions, or information from other parts of a system. This can present a challenge for maintaining independence of eCores in a system, which can be addressed using dynamic dependencies as a characteristic of the interpreCore.

A bi-directional characteristic of the interpreCore may solve the issue of eCore to system and eCore to eCore dependencies. If a developed eCore has dependencies relating to the rest of the system or other eCores, whether it be data, conditions, or the like, then these dependencies may be developed as interpretable function requests into the defining class, in a manner that is specific to itself rather than to not the other parts of the system. For example, if the example loading system as described above with respect to FIG. 3 needs data or a condition checked from another eCore in the system, for example an eCore that is part of a pneumatic subsystem, the loading eCore may be developed in a way that is blind to any other eCores. The loading system performs an interpretable request for data or a condition independently of any implementation or knowledge of which other eCore or subsystem it is requesting from.

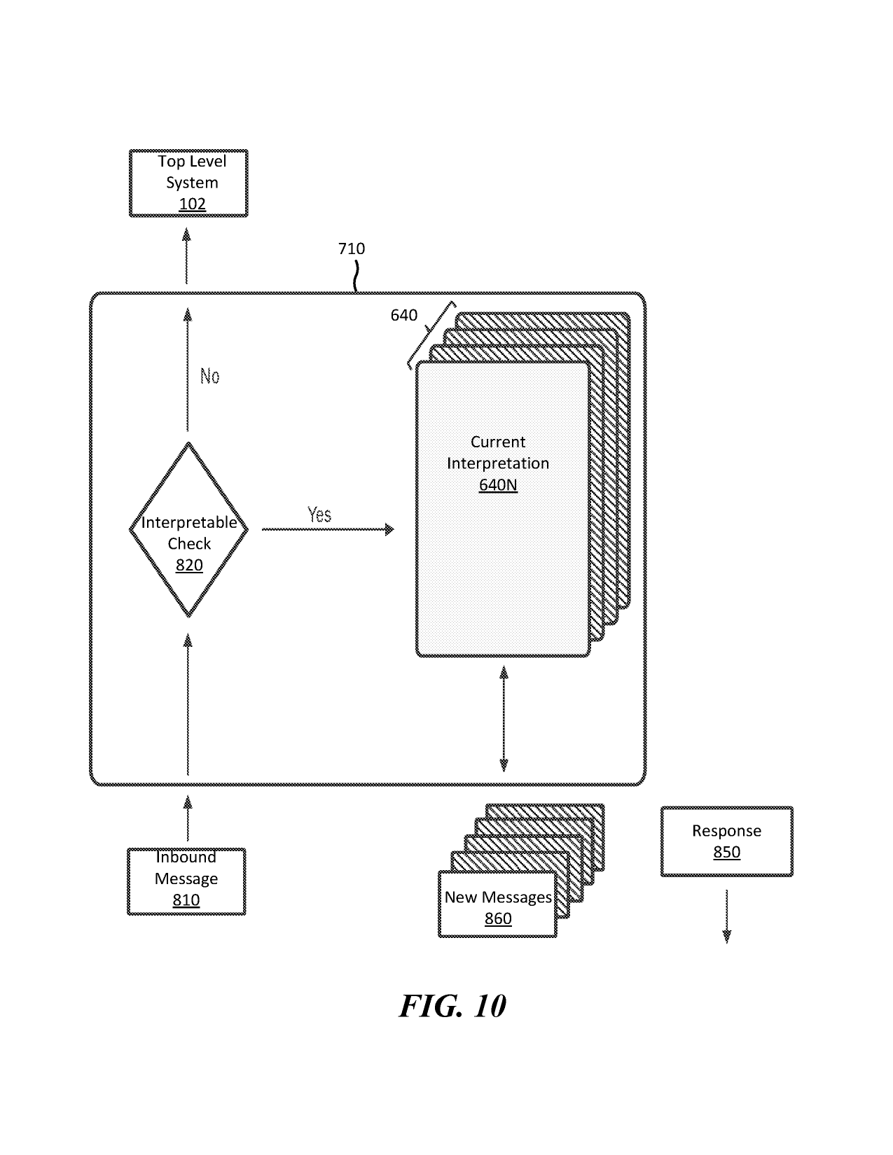

When this building block (in other words, the loading subsystem eCore) is assembled into a framework, the data/condition will be fulfilled/implemented by the interpreCore in the system. FIG. 10 illustrates a flow chart diagram of an interpreCore 710 receiving an inbound message 6=810, such as case a function request for either data, a condition, or something else (e.g., a generic or abstract dependency request). The interpreCore 710 recognizes the request as interpretable in an interpretable check 820, searches the interpretation library 640 and finds the corresponding interpretation matrix (such as the current interpretation 640N). The interpretation matrix for this particular dependency request specifies the implementation and specifics of the dependency. For example, if the eCore requested a simple condition check, such as a true or false, that condition is realized in the interpretation matrix. The interpretation matrix could specify multiple relevant conditions involving other eCores in the lower framework section specific to a particular application and then perform both CLL and other logic before responding to the original requesting eCore and fulfilling its request in the format its interface recognizes. In this manner, an eCore requests an unfulfilled dependency and the interpreCore determines the fulfillment of that dependency in an application specific way. This both solves the problem of dependencies between independent eCores and allows for dynamic dependency fulfillment. If dependencies in a system change, the fulfillment of those dependencies can be comprehensively changed and adapted at our framework logic point-of-contact, the interpreCore 710, as desired. The interpreCore could fulfill the dependency from different eCores, additional eCores, or completely alter the method it fulfills said dependency.

Further referring to FIG. 10, once the interpreCore 710 determines a message is interpretable and opens up the corresponding interpretation matrix, it then performs CLL according to the matrix and distributes other new messages across the network 860, performs logic, and checks conditions/timeouts as specified in the matrix. After interpretation, the interpreCore 710 finishes the matrix and responds to the original requesting eCore with a response 850.

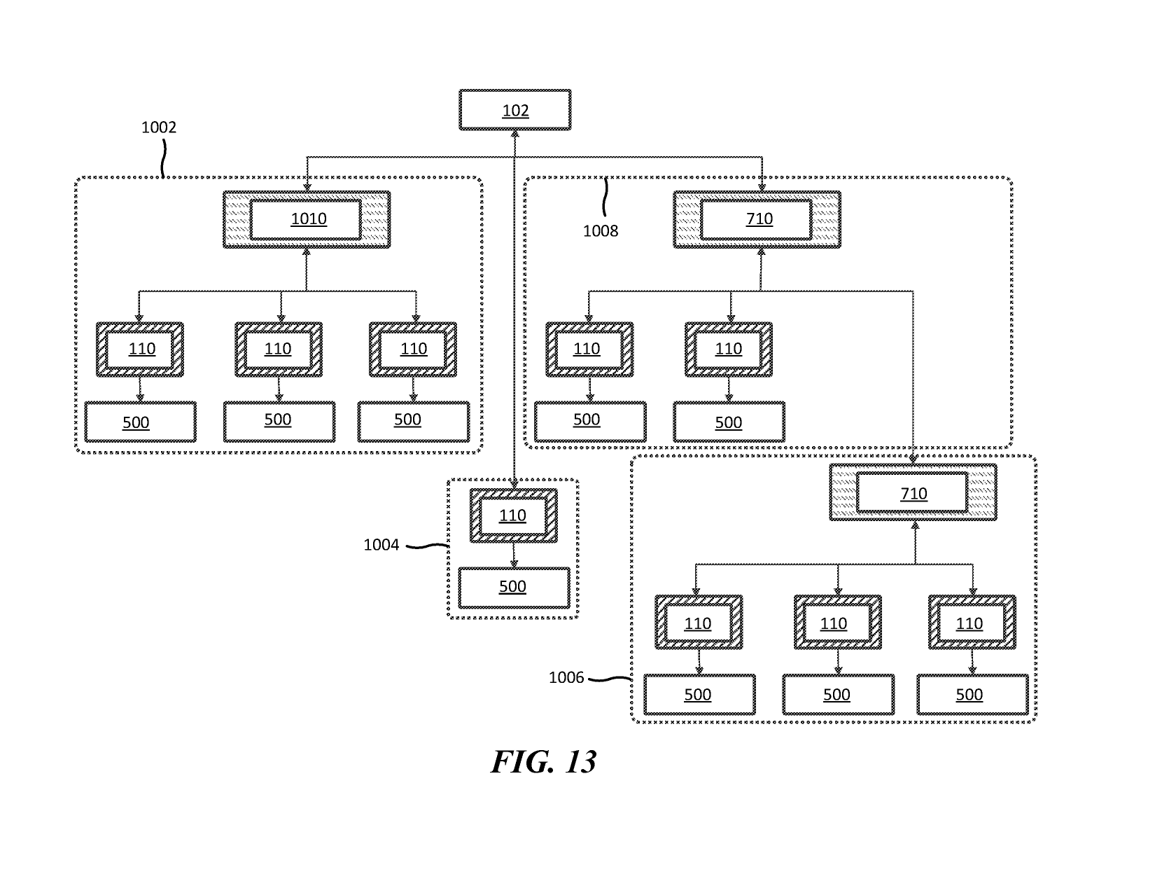

In a multi-section framework, such as the example described below with respect to FIG. 13, the nearest interpreCore 710 may not have the interpretation matrix for a given dependency request if the target is further away in the framework. If this is the case, the nearest interpreCore may determine that the message is not interpretable as illustrated in FIG. 10 and then forward the message upwards to the rest of the framework (e.g., to the top level system 102). This will continue until the request reaches the correct interpreCore and the dependency can be fulfilled and passed back down to the original requesting eCore.

The interpreCore 710 further includes response aggregation functionality. Returning to FIG. 9, a request may come from the greater system (e.g., the top level system 102) for data. For example, the goal may be to collectively obtain data from multiple or all eCores in the lower framework section below the interpreCore 710. Instead of having to individually function request each eCore for data, a generic data collection call can be implemented to be interpreted by the interpreCore 710. The interpreCore 710 then uses an interpretation matrix (e.g., the current interpretation 640N of the interpretation library 640) to convert the single data request into the individual data requests for each required eCore. Then the interpreCore 710 waits for responses for each of the eCores. The interpreCore 710 aggregates the responses into a predefined format as specified in the interpretation matrix and sends one collective, compressed response back into the greater system. An advantage of this approach is that implementation and specifics regarding the eCores, the specific function requests for each eCore, corresponding parameters, and the like are all abstracted away from the greater system and centralized at the point-of-contact interpreCore 710 (as desired). Similarly, it is now easy to extend this single data request with new eCores, format changes, or others by modifying the interpretation matrix for the abstract data request.

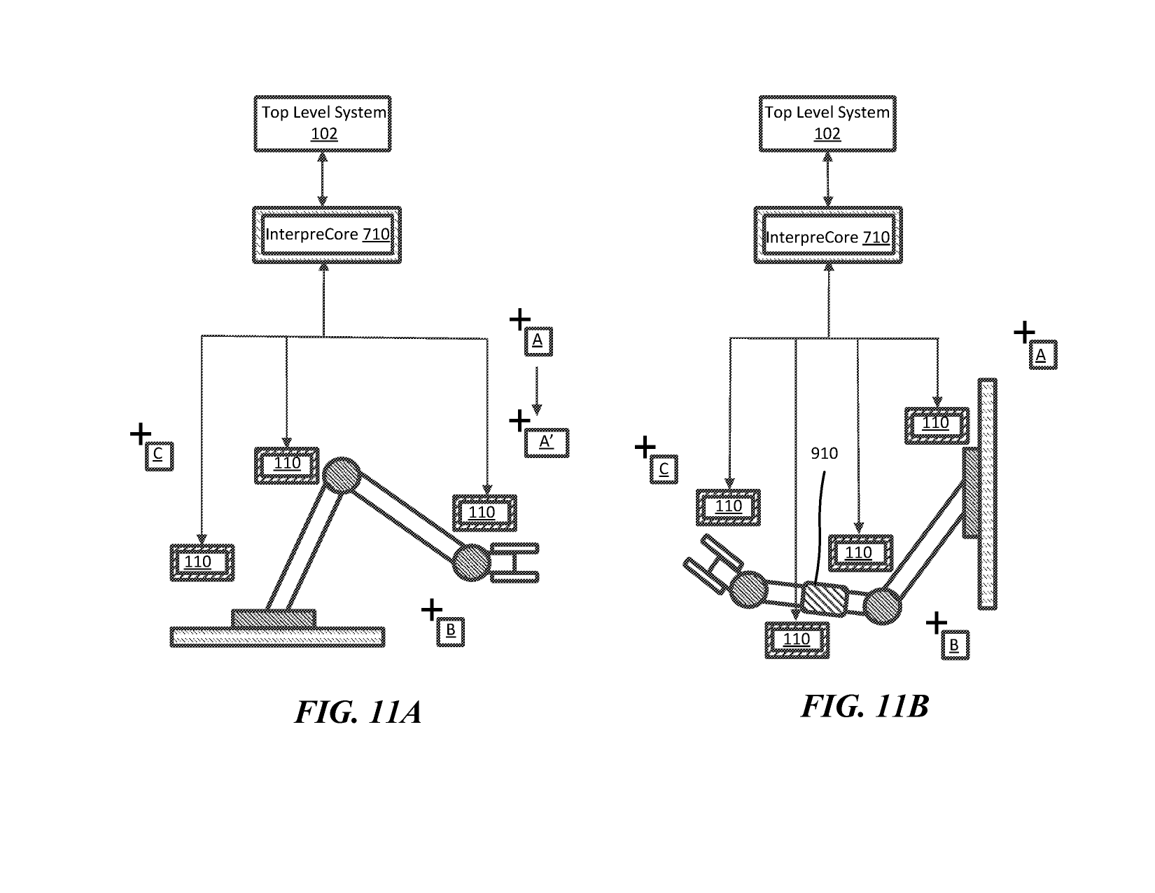

FIGS. 11A and 11B illustrate an example subsystem including a robot arm part of a greater system at intermediate stages of robot operation. Each of the eCores 110 in this case are developed to be dedicated to controlling a single axis of the robot arm and its supporting hardware, thereby creating a generic eCore 110 which can be re-used across axes. A generic interface is set up for the axis eCores 110. Next, an interface is set up to the rest of the greater system (e.g., the top level system 102). This interface is designed abstractly and regards the collection of eCores 110 as a collective subsystem. It requests for the overall robot system to move to an absolute position in the environment. This is illustrated via the positions A, B, and C as illustrated in FIG. 11A. The interpreCore 710 is then used as the framework logic to tie together the eCores 110 and the greater system (e.g., the top level system 102). The interpreCore 710 determines how much to move each axis and in what order to achieve the generic motion requests from the greater system. In this manner, if the environment of the system changes and a target position is moved, this can be adjusted in the interpreCore 710 and the greater system can remain completely unchanged.

In keeping with the goal of centralizing framework logic at the interpreCore 710, a few examples are provided. In a first example the system position A is moved or adjusted as system position A’. This could result from various means, such as physical changes in the system environment. Since the framework and greater system have not yet changed, the greater system still requests motion to position A. However, the framework is not aware of the implementation and specifics of position A; the frame work requests position A without awareness of the implementation and specifics. The system can adjust to adapt to the redefinition of position A to A’ by modifying the interpretation matrix in the interpreCore 710. For example, some parameter values can be changes for the axes of two of the eCores 110 (e.g., the center and right eCores 110) while some of the interpretation matrix remains the same. System logic redefinition is thus achieved with the interpreCore 710 being a single logical touch-point and without anything else in the system needing adjustments.

A second example is described in respect to FIG. 11B, in which the greater system is the same as before and does not change. However, the robot arm subsystem (including the robot arm and the eCores 110) changes from the configuration shown in FIG. 11A to the configuration shown in FIG. 11B. This can include the addition of new axes, a new type of axis, and potentially different brands of hardware, which may result in implementation differences. eCores 110 from the existing system may be reused where possible. One or more new eCore(s) 110 (edge cores) can be developed or added, such as for a new inline axis 910 as illustrated in FIG. 11B, which can take advantage of class based hardware to maximize reuse of existing hardware and software and minimize development time. Once the eCores 110 are deployed and coupled as shown in FIG. 11B, the interpretation lists for positions A, B, and C are modified, which have remained the same from the previous configuration for the greater system as described above with respect to FIG. 11A. The interpretation lists are then modified to fulfill positions A, B, and C for the existing interpretations for the existing, unchanged interface for the greater system (e.g., the top level system 102). The greater system thereby functions in the same manner as before the reconfiguration but with a different hardware implementation. In this example, a reconfiguration of the hardware of a subsystem has been performed while integrating it into the existing greater system without any changes by taking advantage of the characteristics of the interpreCore 710 (such as the ability to modify its interpretation lists).

It can be advantageous to use an interpreCore 710 to decouple implementation of the many different subsystems (e.g., subsystems including an eCore 110) from the greater system (e.g., the top level system 102). Multiple implementations may be used for interpreCores 710. An interpreCore can sit as a physical break on communication lines between the greater system (e.g., the top level system 102) and the lower framework section 700 as illustrated in FIG. 8, and couple the greater system and the lower framework section 700 via software. The interpreCore 710 can also sit parallel on the bus at the same level as the other eCores 110 for which it is responsible, which could help reduce points of failure in the network.

As described above with respect to FIG. 1, eCores 110 may be implemented on off-the-shelf, inexpensive microcontrollers. As such, it is possible to implement an interpreCore 710 in a light-weight manner on such a microcontroller. This implementation may be advantageous for a smaller sub-system with limited interpretation.

In examples where an interpreCore will be doing extensive interpretation with many interpretation matrices and will run many interpretations concurrently, it may be advantageous to use hardware designed for such an application. For example, Ethernet switches are often designed with fast CPUs to reduce latency as much as possible when forwarding message packets. In a similar manner, a multi-purpose CPU or an ASIC can be used to perform interpretation as fast as possible with minimal latency. Support for concurrent interpretation is also beneficial. Since interpretations are often sequences of events and may take noticeable time to complete, multiple interpretations be run concurrently. This can be achieved via advanced coding techniques on limited resources but can be improved by the use of multi-core processors, such as with threading capabilities. Using processors with much faster clock speeds may be further advantageous for reducing latency and increasing processing power.

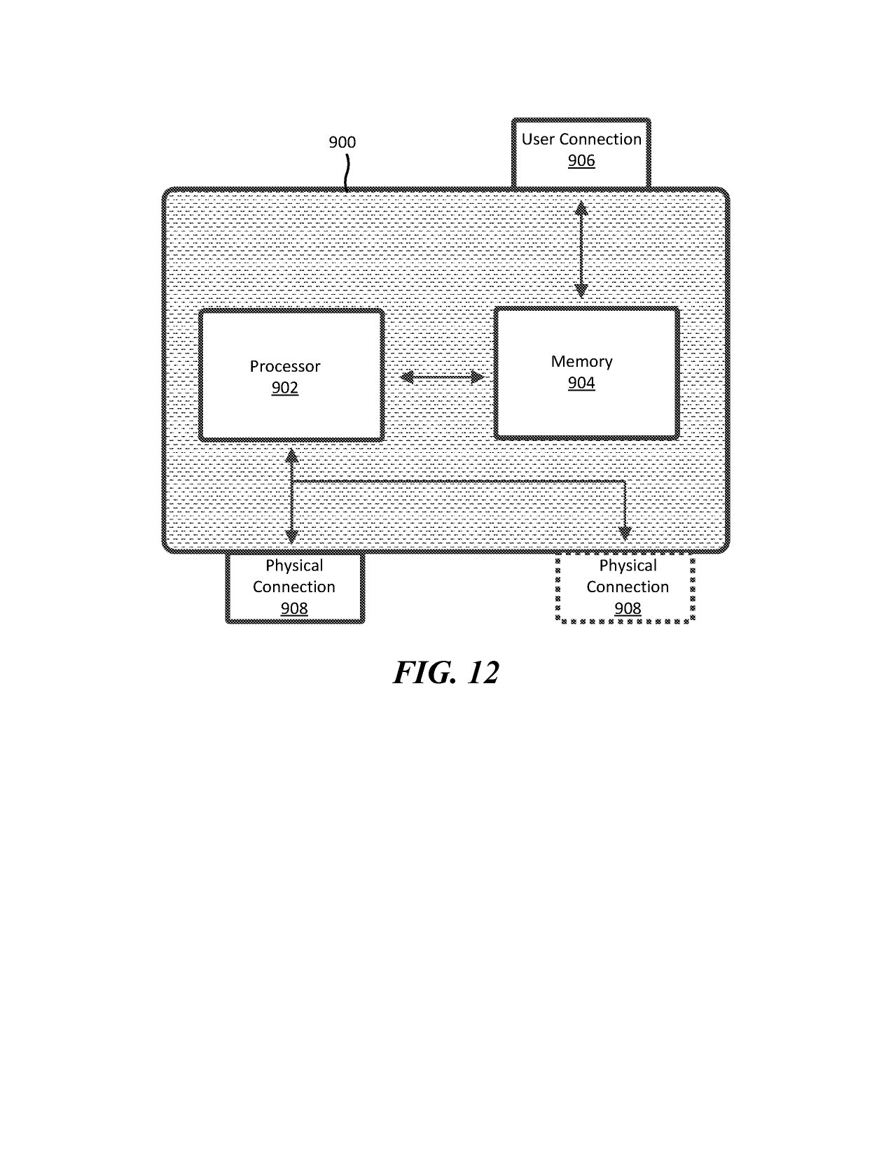

FIG. 12 illustrates an example interpreCore 710, in accordance with some embodiments. Examples of hardware implementations for the interpreCore 900 comprise a physical connection(s) 908 to the desired communication protocol bus, a processor 902 (e.g., an ASIC or general purpose CPU) dedicated to performing interpretations from matrices as fast as possible, a memory 904 for matrices storage, and a user connection 906 (e.g., another physical connection) to allow user modification and addition/removal of matrices. The second physical connection 908 may be a difference between an inline interpreCore, which is a physical break in the communication bus and includes at least two physical bus connections, and a parallel interpreCore, which has a single physical bus connection.

Additionally, in some embodiments an interpreCore is implemented not as a hardware entity as described in the two above approaches but rather entirely in software. If running on a PC that is also part of the framework, the interpreCore can be run in software and intercept messages within the PC before the messages reach the selected physical communication bus. The interpreCore can then use the existing bus connection of the PC to send and receive messages through the rest of the system.

Address/identifier collisions are a probable issue that frameworks or most control systems will face. Even if the framework is designed to ignore the addressing specification of whichever communication method it implements, it will still implement some form of addressing itself at some point. A first method to avoid collisions is to place responsibility for avoiding the network identifier collisions on the developer. For smaller systems, this can be a reasonable request and helps to avoid the additional complexity which accompanies the solution to the problem.

However, as systems scale and potentially involve multiple developers, this request begins to become burdensome. As such, a solution that can prevent such identifier collisions may be implemented as a standalone, independent entity or integrated into an interpreCore.

Disclosed embodiments include a gateway controller (also referred to as a gateway module or gateway) for the system. A method for gaining access to the network includes first directing a message to the gateway controller from the eCore, requesting access to the network and specifying the identifier of the eCore. The gateway keeps a running list of the active components and identifiers in the network and will either reject or accept the request. Once the eCore receives a response from the gateway, it will either enter an active state and join the network, or if rejected, enter a disabled state. In some embodiments, the gateway will operate in a similar manner to a DHCP server but will work in view of the framework and not necessarily the communication protocol. If the gateway receives a request for access for an identifier which already exists in the network, the gateway will try to contact/message an existing identifier corresponding to a component that is in the network. If the existing identifier-related component responds, then the gateway sends a rejection message to the requesting eCore; if it does not respond, the gateway permits access to the network.

The framework configuration for the gateway may use at least two methods, depending on communication protocol. If an addressable communication protocol is used, such as Ethernet, an address can be chosen as the network access request address (similar to the 0.0.0.0 address for DHCP in the internet protocol). In this case, the addressable property of the communication protocol is exploited to implement the gateway. eCores are configured upon startup to send requests to the network access request address and begin normal operation once they have been accepted into the network.

A second method for communication protocols/methods which may not support addressing, such as UART or other parallel non-addressing protocols. For such protocols, the approach can be implemented by introducing a new message type. Such a message includes some specific code or sequence of data specifying that it is a network access request or an identifier that refers to a gateway module. All other eCores and components in the framework may ignore the network access request except for the gateway which specifically handles these requests. In some embodiments, this is also applied to the previous case of addressable protocols in place of the addressing method.

The gateway controller can be implemented in a similar off-the-shelf microcontroller as described above for the eCores 110 with respect to FIG. 1. The gateway controller can implement the same framework handling software with minor modifications. This can provide an effective solution that reduces expenses and integrates into the framework, as the gateway controller acts similarly to another eCore in the system with some universal specifier as the identifier that no other eCores are be allowed to use.

In some embodiments, the gateway controller functionality is integrated into a singular interpreCore. Using a singular interpreCore rather than multiple interpreCores with gateway functionality may be advantageous because if multiple interpreCore are capable of handling the gateway functionality then multiple locations of active eCore tracking will exist and can create network issues if not synchronized could create. The functionality as described above is integrated into the interpreCore software and/or hardware. This may remove the gateway controller as an extra component in the system but can introduce some additional complexity into the interpreCore. It may also be desirable for the developer to ensure that only one interpreCore is specified as the gateway for the system.

The disclosed gateway controller is advantageous by adding network control to prevent name collisions or the like as a module that runs independently of the host (e.g., the top level system) and the controller (e.g., an interpreCore). In some embodiments, the gateway controller is configurable to be overridable to allow the user to be at risk for name and/or addressing collisions. An equivalent system could be free of a gateway controller, which could simplify system complexity.

FIG. 13 illustrates an example multi-level system using these fundamental building blocks, such as eCores 110, with the single-point-of-contact interpreCore(s) 710 to create complex control systems. Section 1002 of FIG. 13 illustrates the example already discussed above with respect to FIG. 8 of a collection of eCores 110 under an interpreCore 710 which mediates between this particular group of eCores 110 and the greater system (e.g., a top level system 102) to create an abstracted interface for the rest of the greater system. In some embodiments, the interpreCore 710 in section 1002 has gateway functionality of a gateway controller, as described above. Individual eCores 110 can also be without interpretation and directly under the greater system, as illustrates by section 1004 of FIG. 13.

eCores are the fundamental building blocks of the disclosed framework, and they implement a developed, static interface that the rest of the greater system can use. In a similar manner, a collection of eCores 110 under an interpreCore 710, as illustrated above in FIG. 8, can be considered as a whole as a consolidated, single eCore when viewed from outside the dotted box of the lower framework section 700 in FIG. 8. This unit, comprising the collection of eCores under an interpreCore, may be referred to as a superCore 1006. This superCore 1006 is integrated underneath the interpreCore 710 of section 1008. In some embodiments, the interpreCore 710 in section 1008 is not aware of the difference between the two eCores 110 in its section 1008 or between the eCores 110 and the superCore 1006 which is also coupled with it. All implement some set interface and appear as an eCore to other system components, illustrating the advantage of the modular framework. SuperCores 1006 can be applied in a recursive manner (such as superCores coupled in superCores coupled in superCores and so on) to create advanced and complex systems, all while breaking down into the fundamental, independent, decoupled building blocks (such as eCores 110) and keeping framework logic centralized at the point-of-contact interpreCore 710. The method of design and operation can improve framework stability, modularity, extensibility, reconfigurability, and also hardware/software (e.g., eCore) re-use between projects and applications. As more and more of these independent, abstract, decoupled units/subsystems (such as eCores) are developed over time, system design, development, and iteration can become faster and faster, particular if there is some level of correlation/similarities between projects and applications (which exists in the semiconductor research and development sector).Additionally, many or nearly all of the above disclosed design benefits and characteristics of eCores, such as OOH, apply also to the design and development of superCores.

In various embodiments, interpreCores are used for cumulative network traffic management. As described above with respect to FIG. 12, an interpreCore can be implemented as a device that sits in parallel with the communication bus (in other words, with no physical break in the communication bus), or as a device that sits inline the communication bus (in other words, as a device that creates a physical break in the communication bus, essentially dividing and creating a sub-network). As an example of such inline, physically separating interpreCores, FIG. 13 illustrates four different sub-networks in the greater framework. The first sub-network is between the greater system (e.g., the top level system 102) and the interpreCore 702 in section 1002, the eCore 110 in section 1004, and the interpreCore 710 in section 1008. The second sub-network is the network underneath the interpreCore 710 in section 1002, the third sub-network is the network underneath the interpreCore 710 in section 1008, and the fourth sub-network is the network underneath the interpreCore 710 in the superCore 1006. In operation, the framework appears as one interconnected network.

However, when using an interpreCore which creates a physical divide in the network, thereby creating a subnetwork, this quality can be exploited for multiple benefits. First, each interpreCore 710 can track the eCores 110 which are in its sub-network by unobtrusively intercepting and reading network access requests. The interpreCore 710 can filter network traffic entering the sub-network. If a message is broadcast in an upper network which is not for an identifier in the sub-network of the interpreCore 710, it can decide not to forward a message. This can help mitigate unnecessary network traffic and improve efficiency. This works because any new eCore 110 added underneath the interpreCore 710 in a section such as section 1002 will send out network access requests across the network, which will be picked up by the interpreCore 710 of that particular sub-network. And since this functionality works for eCores 110 underneath an interpreCore 710, other interpreCores 710 such as the interpreCore 710 in section 1008 will not add an eCore 110 from section 1002 if the interpreCore 710 in section 1002 with gateway functionality (also referred to as a gateway interpreCore) forwards a network access request up to the greater system (e.g., the top level system 102) after registering for network access, since this request would not come from underneath but from above interpreCore 710 in section 1008.

All network requests are forwarded by interpreCores for cumulative network traffic management. As such, network access requests also occurs upwards, so filtering automatically happens in multiple layers when interpreCores 710 are stacked, as illustrated by the superCore 1006 and section 1008. If an eCore 110 (edge core) is added under the interpreCore 710 in superCore 1006, the interpreCore 710 in the superCore 1006 would first intercept the network access request and add it to its active modules (e.g., eCores 110) since the request originated from underneath the interpreCore 710, it would. The interpreCore 710 in superCore 1006 then forwards the request up the framework, so that the request will reach interpreCore 710 of section 1008. The interpreCore 710 of section 1008 also intercepts this request, and since it also originated underneath the interpreCore 710 of section 1008, the identifier is also be added to the list of active modules of interpreCore 710 of section 1008. The interpreCore 710 of section 1008 then continues and forwards the request again as the message propagates to the gateway or gateway interpreCore (e.g., the interpreCore 710 of section 1002). The message then also hits the interpreCore in section 1002, but since the network access request originated from above rather than underneath it, the network access request is ignored and the new eCore 110 is not added. However, since the interpreCore 710 of section 1002 in the illustrated example is the gateway in the network, it does register the identifier in the active module tracking for network access reasons. In this manner, when many interpreCores are nested recursively, network filtering happens cumulatively as requests move up through the framework, potentially reducing significant unnecessary network traffic and improving efficiency.

In various embodiments, the present disclosure provides a control system framework that aims to achieve distributed control, or local computing, through controllers architected within the framework. The controllers in this system are based on microcontrollers, where each microcontroller may have two or more CPU cores, although implementations with a single core are also possible. Each microcontroller implements a defined software framework on a single unit.

In one or more embodiments, the system includes eCores which implement a communication core and a task handling core. These eCores control hardware targets, acting as an abstraction layer between hardware targets or peripherals and upper controllers, similar to how a hardware abstraction layer functions between specific hardware of a computer and a generic operating system. The eCores are capable of providing significant functionality and control of the hardware, with the specific functionality determined and developed at the discretion of the user.

In some embodiments, the system includes interpreCores. These controllers may implement two communication cores, one for upstream and one for downstream communications. An interpreCore may be placed inline on the communication bus between an upper controller and one or many lower eCores or other subservient controllers. One core handles the upper communication while the other manages the lower communications, creating the appearance of an unbroken communication line. The interpreCore may rely on a preset interpretation list which specifies command handling behavior. This behavior can include allowing received commands from upstream controllers to propagate to specific sub-controllers below the interpreter controller, multiplying or broadcasting a single received command to some or all sub-controllers, translating or manipulating a received command into one or many commands or into a sequence of different commands for sub-controllers, and aggregating and processing data or responses received from sub-controllers into a single formatted, collective response to send back to the upstream controller.

In various embodiments, all controllers in the system communicate over a selected communication protocol, which may be an existing protocol or a custom one, and may be wired or wireless, implemented according to the requirements of the user. Each controller implements a user-defined communication method between itself and a host or master controller, typically in the form of a command list within the communication protocol. These methods or lists are specific to a single host-to-servant connection, allowing for significant flexibility in system design.

In one or more embodiments, the controllers are capable of in-place troubleshooting. This feature allows a user to connect directly to an individual controller deployed in the control system and view status messages, updates, error messages, and other information via a direct connection to the controller, without any intermediary. This troubleshooting capability can be used for both communication issues and controller functionality or control issues, status checks, and other diagnostics. Importantly, this method operates independently from the main communication system, serving as a secondary connection to the controller.

In some embodiments, the controllers are designed for independent creation and testing. Testing can be performed by setting up an environment that implements the chosen communication protocol and sends commands or requests from the user-defined, controller-specific command list. This approach allows each controller to be tested in an environment identical to, yet independent from, the final deployment environment.

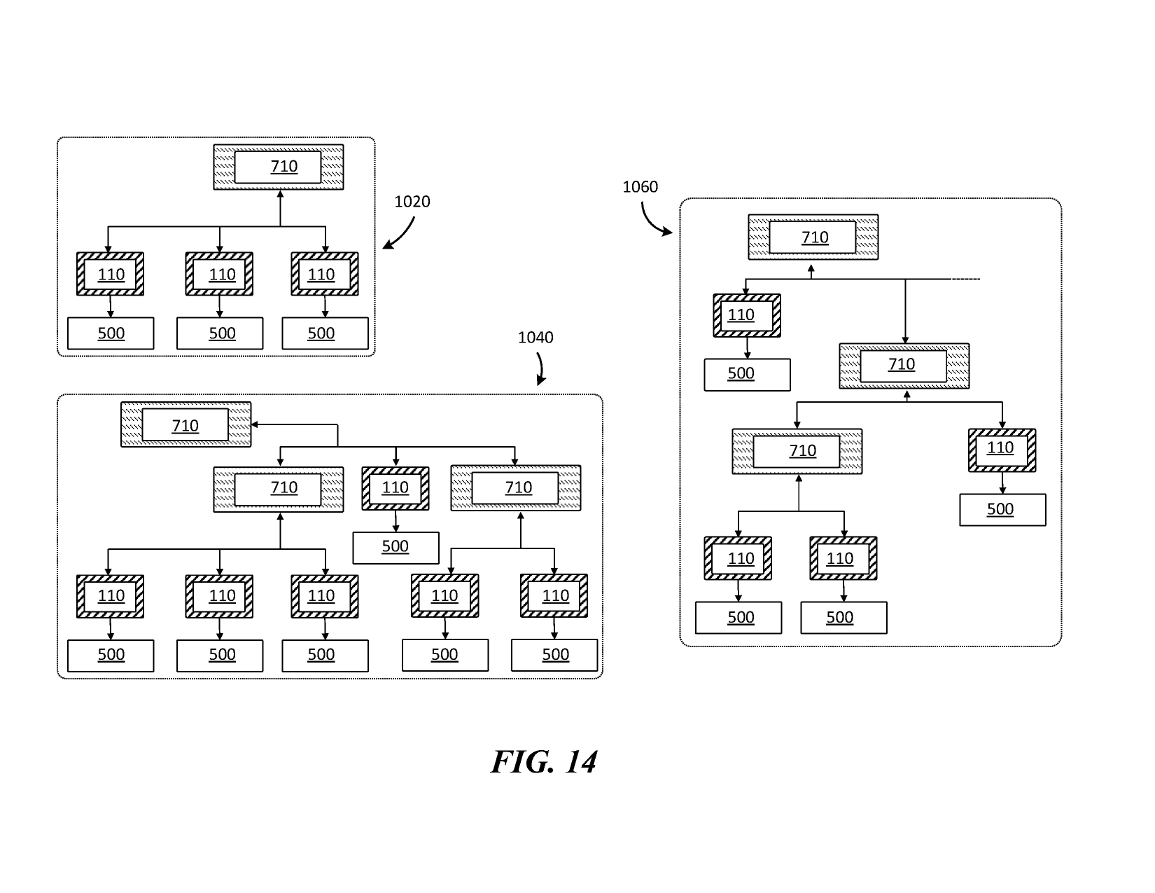

FIG. 14 illustrates a block diagram of different order superCores. A first order superCore 1020 comprises an interpreCore 710 and multiple eCores 110 coupled below it. A second order superCore 1040 may take some first order superCores 1020 and possibly some eCores 110 as well and combine them together with another interpreCore, thus creating the second order superCore 1040. In the second order superCore 1040, one interpreCore 710 is coupled below another interpreCore 710, with each interpreCore 710 also being coupled with one or more eCores 110. This can go on recursively as illustrated by the third order superCore 1060 in which three interpreCores 710 are coupled in series with each interpreCore 710 also being coupled with one or more eCores 110. This illustrates how these simple fundamental building blocks can be used to create very complex, yet modularized and reusable structures in a larger control system, while separating common, reusable building blocks (eCores) from the one-touch points of logic which tie them together in the greater system (interpreCores).

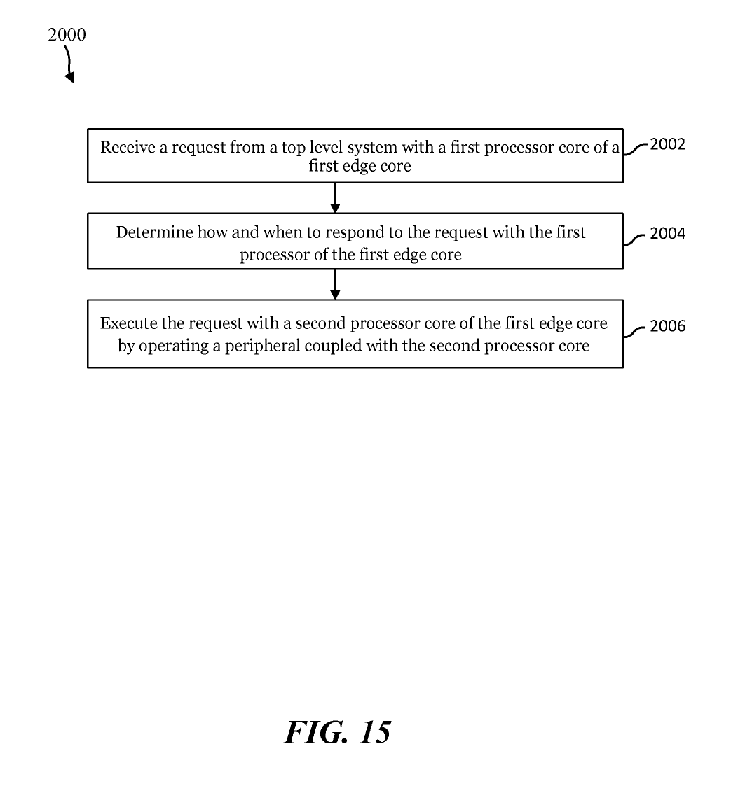

FIG. 15 illustrates a process flow chart diagram of a method 2000 for controlling a device, in accordance with some embodiments. The device is controlled with a module described as an eCore (also referred to as an edge core), which is an independent building block for the described control system method. In various embodiments, the eCore comprises a first hardware unit (e.g., a processor core) built to implement a particular communication protocol and a second hardware unit that encapsulates and controls a subsystem in a larger system but with no direct dependencies (e.g., dynamic dependencies) anywhere else in the larger system.

In step 2002, a first processor core of a first edge core receives a request (also referred to as a command) from a top level system, as described above with respect to FIG. 1. In step 2004, the first processor of the first edge core determines how and when to respond to the request, as described above with respect to FIG. 2. In step 2006, a second processor core of the first edge core executes the request by operating a peripheral coupled with the second processor core, as described above with respect to FIG. 1. Receiving a request from a top level system with a first processor core of a first edge core, determining how and when to respond to the request with the first processor core of the first edge core, and executing the request with a second processor core of the first edge core by operating a peripheral coupled with the second processor core is advantageous because, for example, it provides one processor core that is dedicated to an existing communication standard and another processor core that is dedicated to hardware handling, allowing for internal software framework handling both communication and functionality in a single edge core.

In some embodiments, the first edge core is developed and programmed with a software package comprising a defining class, a class linkage method for linking the defining class for the first edge core, and a framework messaging scheme. The defining class of the software package defines what the first edge core is or what subsystem it is, or the like. The linked defining class subsequently defines the functionality of the first edge core by its class methods and its command/request set.

In some embodiments, a second edge core is programmed with a child implementation of an existing edge core class (e.g., the defining class of the first edge core). This child implementation may define the same methods but with a potentially different implementation and may also adding new functionality by adding new methods. An abstract defining class may be an interface from which child edge core defining classes inherit. As such, the method of Object Oriented Hardware is integrated directly into the particular control system method.

In some embodiments, the first edge core is troubleshooted with another core operating concurrently and independently from cores of the first edge core. The independent core may be dedicated to sending out serial troubleshooting/status data, such as UART, USB, or the like. Troubleshooting data may be constantly transmitted regardless of the state of a receiving unit (e.g., the independent core), and connection of a receiving unit has no effect, coupling, or interruption of the first edge core in any way.

In some embodiments, the first edge core switches from running a first subsystem software package to running a second subsystem software package in response to a request, an external trigger, or an internal trigger. The first edge core may execute this switch by changing its defining class and thus its functionality. This change potentially includes hardware reconfiguration as well, such as vby IO remapping, hardware multiplexing (MUXing), or the like.

In some embodiments, the request is broadcast to a plurality of edge cores, the first edge core being part of the plurality of edge cores, and the first edge core checks the request for an identifier or address. The request is checked for an identifier or address in either hardware or software in order to determine how to handle the request at its own discretion.

In some embodiments, a second edge core is hot swapped with the first edge core. This may be achieved as a direct result of applying Object Oriented Hardware (OOH). If multiple edge cores have defining classes which share a common interface, or if a new edge core has been developed as a child implementation of the original defining class, it is hot swappable in the control system with no reconfiguration or changes needed elsewhere. Functionality for the edge core(s) can thus be expanded and/or redefined independently from the rest of the system.

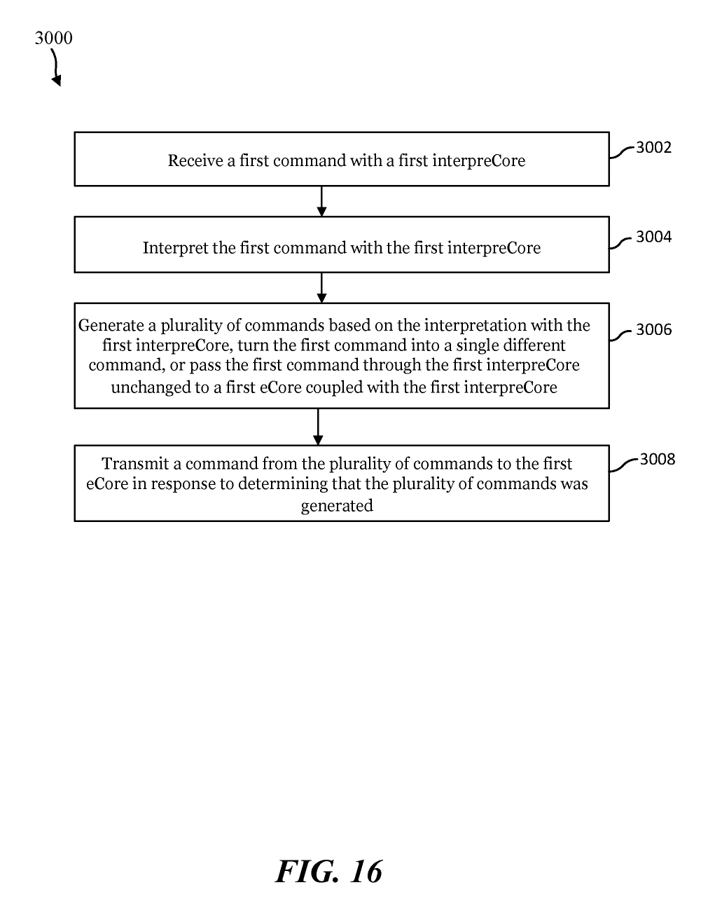

FIG. 16 illustrates a process flow chart diagram of a method 3000 for controlling a device, in accordance with some embodiments. InterpreCores are units in a system which are dependent on the rest of the system and act as one-touch points of logic which tie together independent eCores (edge cores) into larger functional systems.

In step 3002, a first command is received with a first interpreCore, as described above with respect to FIG. 8. In step 3004, the first command is interpreted with the first interpreCore, as described above with respect to FIG. 9. In step 3006, either a plurality of commands are generated based on the interpretation with the first interpreCore, the first command is turned into a single different command, or the first command is passed through the first interpreCore unchanged to a first eCore coupled with the first interpreCore, as described above with respect to FIG. 9. In step 3008, in response to determining that the plurality of commands were generated, a command from the plurality of commands is transmitted to the first eCore, as described above with respect to FIG. 9. A method including receiving a first command with a first interpreCore, interpreting the first command with the first interpreCore, generating a plurality of commands based on the interpretation with the first interpreCore, turning the first command into a single different command, or passing the first command through the first interpreCore unchanged to a first eCore coupled with the first interpreCore, and in response to determining that the plurality of commands were generated, transmitting a command from the plurality of commands to the first eCore is advantageous because, for example, the first interpreCore is used as the single point of logic to tie network components (e.g., the first eCore and the like) together into a functioning system, thus centralizing the framework logic into a single-point of contact and allowing for the use of command-level logic.

In some embodiments, interpreting the first command (in other words, a received request) with the first interpreCore is performed at a command level, also referred to as a message level. This interpretation is logic which is performed at the command level and may thus be referred to as Command Level Logic (CLL). In various embodiments, it is command level logic performed at the interpreCore that creates the logic for a larger system from all the commands of various eCores in a system and thereby improves abstraction.

In some embodiments, the first eCore requests an unfulfilled abstract dependency and the first interpreCore determines fulfillment of the unfulfilled abstract dependency. This further follows the desired method of the control system method in which eCores remain independent from the rest of the system and dependencies are placed at the one-touch points of logic, the interpreCores.

In some embodiments, the first interpreCore aggregates responses from a plurality of eCores and sends a formatted, collective response to a top level system, the collective response comprising the aggregated responses. The format of the aggregated responses may be defined at the first interpreCore in its interpretation matrix.

In some embodiments, generating a plurality of commands based on the interpretation with the first interpreCore comprises determining how much to move a robot arm around multiple axes of the robot arm. An example interpreCore control scheme for a robot arm is illustrated in FIG. 11A. An eCore 110 of the control scheme acts as a motor subsystem controller that is a building block of the system to be built, with one eCore 110 being assigned to each axis of the robot. The top level system 102 is the rest of the system that aims to interact with the robot system in an abstract manner from the fine details of each individual eCore 110. The interpreCore 710 performs interpretation of a defined list of abstract commands received from the top level system 102 according to its interpretation matrix and distributes commands as necessary to the eCores 110 in the robot system. A, B, and C are points in the system to where the robot needs to move that have been defined at the interpreCore 710 in the interpretation matrices.

When the system is reconfigured from the system illustrated by FIG. 11A to the system illustrated by FIG. 11B, some new eCores 110 are added and the robot has a drastically changed configuration. However, the general functionality remains the same, as do the target points A, B and C. The new system illustrated by FIG. 11B may be controlled by changing just the interpretation matrices in the interpreCore 710. The abstract requests from the top level system 102 and the eCores 110 do not change while the implementation of the interpretation matrices for each request do change, with the interpreCore 710 acting as a one-touch point of logic.

In some embodiments, a gateway controller coupled with the first interpreCore tracks active eCores by their respective identifiers and/or addresses. If the gateway controller denies access due to a identifier or address collision, the eCore is not able join the network and thus the control system.

In some embodiments, the command is sent to the first interpreCore from a second interpreCore. In some embodiments, the second interpreCore sends a second command to a second eCore, with the second eCore being directly connected with the second interpreCore. In some embodiments, the second command is further sent to the first interpreCore. As an example, a method for building a larger scale control system out of the fundamental building blocks, eCores 110, and the one-touch points of logic, interpreCores 710, is described above with respect to FIG. 13, in which there are multiple sections of eCores 110 grouped under an interpreCore 710, such as in section 1002, or even multi-level interpreCores as shown by section 1008. FIG. 13 further illustrates a superCore 1006. As described above, an eCore (edge core) is an independent entity which implements some defined request/command set. When considering the superCore 1006 in FIG. 13, in which some eCores 110 are grouped under an interpreCore 710, the rest of the system views the superCore 1006 essentially as an eCore, as it is an entity which implements some defined request/command set. The rest of the system only interacts with the top level interface defined by the top interpreCore 710 and does not care about other interfaces and implementation details below the interpreCore 710 inside the superCore 1006. This superCore 1006, however, comprises an interpreCore 710 tying together multiple eCores 110, each of which has its own detailed command set and defines an abstract command set for 1006 as a whole which the rest of the system can use for the superCore 1006. As described above with respect to FIG. 14, superCores can be recursive.

In some embodiments, the first interpreCore is used as a break in a communication interconnection between a top level system coupled with the first interpreCore and a superCore coupled with the first interpreCore. An interpreCore can be designed to sit as a physical break in the communication interconnection, thereby physically ‘isolating’ a superCore from the other network interconnections. If an interpreCore is configured to track which modules are underneath it (such as in a superCore coupled to the interpreCore), then when receiving a command the interpreCore can decide whether or not that command is for a module within the superCore and does not need to leave the physically isolated network of the superCore, or whether the command should be passed to the greater system. By doing this, network traffic can be reduced since commands will not be passed through the system when unnecessary. The resulting network is a collection of smaller isolated subnetworks divided by the interpreCores.

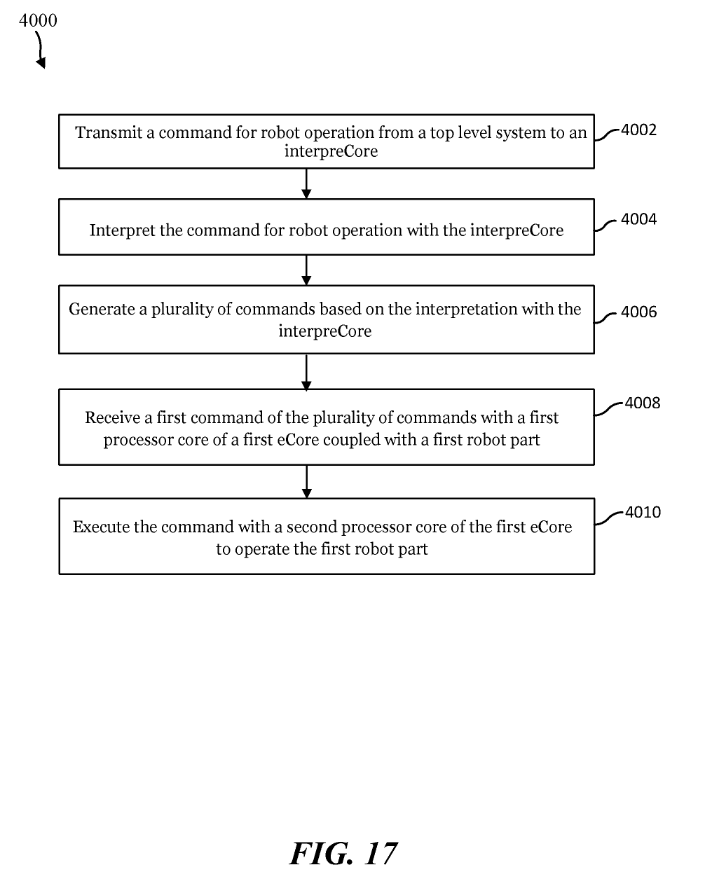

FIG. 17 illustrates a process flow chart diagram of a method 4000 of operating a robot, in accordance with some embodiments. In step 4002, a command for robot operation is transmitted from a top level system to an interpreCore, as described above with respect to FIG. 11A. In step 4004, the command for robot operation is interpreted with the interpreCore, as described above with respect to FIG. 9. In step 4006, a plurality of commands are generated based on the interpretation with the interpreCore, as described above with respect to FIG. 9. In step 4008, a first command of the plurality of commands is received with a first processor core of a first eCore, as described above with respect to FIG. 11A. The first eCore is coupled with a first robot part. In step 4010, the command is executed with a second processor core of the first eCore to operate the first robot part, as described above with respect to FIG. 11A. A method including transmitting a command for robot operation from a top level system to an interpreCore, interpreting the command for robot operation with the interpreCore, generating a plurality of commands based on the interpretation with the interpreCore, receiving a first command of the plurality of commands with a first processor core of a first eCore, the first eCore being coupled with a first robot part, and executing the command with a second processor core of the first eCore to operate the first robot part is advantageous because, for example, it allows for adjusting to a change in the system environment (e.g., including a change of target position) by adjusting programming within the interpreCore while letting the rest of the system remain unchanged.

Example embodiments of the disclosure are summarized here. Other embodiments can also be understood from the entirety of the specification as well as the claims filed herein.

Example 1. A method for controlling a device, the method including: receiving a request from a top level system with a first processor core of a first edge core; determining, with the first processor core of the first edge core, how and when to respond to the request; and executing the request with a second processor core of the first edge core by operating a peripheral coupled with the second processor core.

Example 2. The method of example 1, where the first edge core is programmed with a software package including a defining class, a class linkage method for linking the defining class for the first edge core, and a framework messaging scheme.

Example 3. The method of example 2, further including programming a second edge core with a child implementation of the defining class.

Example 4. The method of one of examples 1 to 3, further including troubleshooting the first edge core with another core operating concurrently and independently from cores of the first edge core.

Example 5. The method of one of examples 1 to 4, further including the first edge core switching from running a first subsystem software package to running a second subsystem software package in response to a request, an external trigger, or an internal trigger.

Example 6. The method of one of examples 1 to 5, where the request is broadcast to a plurality of edge cores, the first edge core being part of the plurality of edge cores, and where the first edge core checks the request for an identifier or address.

Example 7. The method of one of examples 1 to 6, further including hot swapping a second edge core with the first edge core.

Example 8. A method for controlling a device, the method including: receiving a first command with a first interpreCore; interpreting the first command with the first interpreCore; generating a plurality of commands based on the interpretation with the first interpreCore, turning the first command into a single different command, or passing the first command through the first interpreCore unchanged to a first eCore coupled with the first interpreCore; and in response to determining that the plurality of commands were generated, transmitting a command from the plurality of commands to the first eCore.

Example 9. The method of example 8, where interpreting the first command with the first interpreCore is performed at a command level.

Example 10. The method of one of examples 8 or 9, further including: the first eCore requesting an unfulfilled abstract dependency; and the first interpreCore determining fulfillment of the unfulfilled abstract dependency.

Example 11. The method of one of examples 8 to 10, further including the first interpreCore aggregating responses from a plurality of eCores and sending a formatted, collective response to a top level system, the collective response including the aggregated responses.

Example 12. The method of one of examples 8 to 11, where generating a plurality of commands based on the interpretation with the first interpreCore includes determining how much to move a robot arm around multiple axes of the robot arm.

Example 13. The method of one of examples 8 to 12, further including tracking active eCores with a gateway controller coupled with the first interpreCore, the gateway controller being configured to track eCores by their respective identifiers.

Example 14. The method of one of examples 8 to 13, where the first command is sent to the first interpreCore from a second interpreCore.

Example 15. The method of example 14, further including the second interpreCore sending a second command to a second eCore, the second eCore being directly connected with the second interpreCore.

Example 16. The method of example 15, where the second command is further sent to the first interpreCore.

Example 17. The method of one of examples 8 to 16, further including using the first interpreCore as a break in a communication interconnection between a top level system coupled with the first interpreCore and a superCore coupled with the first interpreCore.

Example 18. A method of operating a robot, the method including: transmitting a command for robot operation from a top level system to an interpreCore; interpreting the command for robot operation with the interpreCore; generating a plurality of commands based on the interpretation with the interpreCore; receiving a first command of the plurality of commands with a first processor core of a first eCore, the first eCore being coupled with a first robot part; and executing the command with a second processor core of the first eCore to operate the first robot part.

Example 19. The method of example 18, further including receiving a second command of the plurality of commands with a second eCore, the second eCore being coupled with a second robot part.

Example 20. The method of example 19, further including adjusting a system position of the first robot part by modifying an interpretation matrix in the interpreCore.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for controlling a device, the method comprising:
receiving a request from a top level system with a first processor core of a first edge core;
determining, with the first processor core of the first edge core, how and when to respond to the request; and
executing the request with a second processor core of the first edge core by operating a peripheral coupled with the second processor core.

2. The method of claim 1, wherein the first edge core is programmed with a software package comprising a defining class, a class linkage method for linking the defining class for the first edge core, and a framework messaging scheme.

3. The method of claim 2, further comprising programming a second edge core with a child implementation of the defining class.

4. The method of claim 1, further comprising troubleshooting the first edge core with another core operating concurrently and independently from cores of the first edge core.

5. The method of claim 1, further comprising the first edge core switching from running a first subsystem software package to running a second subsystem software package in response to a request, an external trigger, or an internal trigger.

6. The method of claim 1, wherein the request is broadcast to a plurality of edge cores, the first edge core being part of the plurality of edge cores, and wherein the first edge core checks the request for an identifier or address.

7. The method of claim 1, further comprising hot swapping a second edge core with the first edge core.

8. A method for controlling a device, the method comprising:
receiving a first command with a first interpreCore;
interpreting the first command with the first interpreCore;
generating a plurality of commands based on the interpretation with the first interpreCore, turning the first command into a single different command, or passing the first command through the first interpreCore unchanged to a first eCore coupled with the first interpreCore; and
in response to determining that the plurality of commands were generated, transmitting a command from the plurality of commands to the first eCore.

9. The method of claim 8, wherein interpreting the first command with the first interpreCore is performed at a command level.

10. The method of claim 8, further comprising:
the first eCore requesting an unfulfilled abstract dependency; and
the first interpreCore determining fulfillment of the unfulfilled abstract dependency.

11. The method of claim 8, further comprising the first interpreCore aggregating responses from a plurality of eCores and sending a formatted, collective response to a top level system, the collective response comprising the aggregated responses.

12. The method of claim 8, wherein generating a plurality of commands based on the interpretation with the first interpreCore comprises determining how much to move a robot arm around multiple axes of the robot arm.

13. The method of claim 8, further comprising tracking active eCores with a gateway controller coupled with the first interpreCore, the gateway controller being configured to track eCores by their respective identifiers.

14. The method of claim 8, wherein the first command is sent to the first interpreCore from a second interpreCore.

15. The method of claim 14, further comprising the second interpreCore sending a second command to a second eCore, the second eCore being directly connected with the second interpreCore.

16. The method of claim 15, wherein the second command is further sent to the first interpreCore.

17. The method of claim 8, further comprising using the first interpreCore as a break in a communication interconnection between a top level system coupled with the first interpreCore and a superCore coupled with the first interpreCore.

18. A method of operating a robot, the method comprising:
transmitting a command for robot operation from a top level system to an interpreCore;
interpreting the command for robot operation with the interpreCore;
generating a plurality of commands based on the interpretation with the interpreCore;
receiving a first command of the plurality of commands with a first processor core of a first eCore, the first eCore being coupled with a first robot part; and
executing the command with a second processor core of the first eCore to operate the first robot part.

19. The method of claim 18, further comprising receiving a second command of the plurality of commands with a second eCore, the second eCore being coupled with a second robot part.

20. The method of claim 19, further comprising adjusting a system position of the first robot part by modifying an interpretation matrix in the interpreCore.
